(19) United States
(12) Patent Application Publication
(10) Pub. No.: US 2026/0279817 A1
(43) Pub. Date: Sep. 17, 2026

(54) BINDER FOR NONAQUEOUS SECONDARY BATTERY ELECTRODE, BINDER COMPOSITION FOR NONAQUEOUS SECONDARY BATTERY ELECTRODE, SLURRY FOR NONAQUEOUS SECONDARY BATTERY ELECTRODE, NONAQUEOUS SECONDARY BATTERY ELECTRODE, AND NONAQUEOUS SECONDARY BATTERY

(71) Applicant: RESONAC CORPORATION, Tokyo (JP)

(72) Inventors: Kazunari FUKASE, Tokyo (JP); Keito NAKAYAMA, Tokyo (JP); Kazuhiko OGA, Tokyo (JP)

(73) Assignee: RESONAC CORPORATION, Tokyo (JP)

(21) Appl. No.: 19/473,621

(22) PCT Filed: Oct. 5, 2023
(86) PCT No.: PCT/JP2023/036320

§ 371 Date: Oct. 8, 2025

(51) Int. Cl. H01M 4/62

(52) U.S. Cl. CPC H01M 4/622

(57) ABSTRACT

Provided is a binder for a nonaqueous secondary battery electrode in which a copolymer having 4.0 to 75.0 mol % of a structural unit derived from a monomer represented by Formula (I) (R¹ represents a hydrogen atom or a methyl group, R² represents a hydrogen atom or a hydroxy group, and m and n each represent 0 or 1), and 25.0 to 96.0 mol % of a structural unit derived from a monomer represented by Formula (II) (R³ represents a hydrogen atom, a methyl group, or CH₂COOX², and X¹ and X² each represent a hydrogen atom, an alkali metal, or NH₄) is contained.

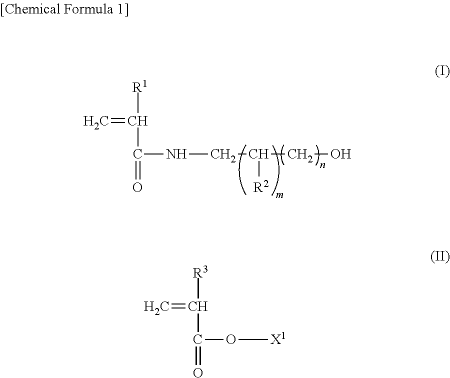

### TECHNICAL FIELD

The present invention relates to a binder for a nonaqueous secondary battery electrode, a binder composition for a nonaqueous secondary battery electrode, a slurry for a nonaqueous secondary battery electrode, a nonaqueous secondary battery electrode, and a nonaqueous secondary battery.

### BACKGROUND ART

Nonaqueous secondary batteries using a nonaqueous electrolyte are superior to secondary batteries using an aqueous electrolyte in terms of high voltage, size reduction, and weight reduction. Therefore, nonaqueous secondary batteries are widely used as power sources for notebook computers, mobile phones, electric tools, or electronic communication devices. In addition, nonaqueous secondary batteries have also been recently used for electric vehicles and hybrid vehicles from the viewpoint of application to environmental vehicles. There is a strong demand for nonaqueous secondary batteries used in automobiles that have higher output, higher capacity, and longer life. Representative examples of the nonaqueous secondary batteries include lithium ion secondary batteries.

A nonaqueous secondary battery includes a positive electrode using a metal oxide or the like as an electrode active material, a negative electrode using a carbon material such as graphite as an electrode active material, and a nonaqueous electrolyte solution mainly composed of carbonates or flame-retardant ionic liquids. In the nonaqueous secondary battery, ions move between a positive electrode and a negative electrode to charge and discharge the battery.

The positive electrode of the nonaqueous secondary battery is obtained by a method including applying a positive electrode slurry containing an electrode active material such as a metal oxide and a binder to a surface of a collector formed of aluminum foil or the like, drying the slurry to form a positive electrode active material layer, and cutting the layer into an appropriate size. The negative electrode of the nonaqueous secondary battery is obtained by a method including applying a negative electrode slurry containing an electrode active material such as a carbon material or a silicon-based material and a binder to a surface of a collector such as copper foil, drying the slurry to form a negative electrode active material layer, and cutting the layer into an appropriate size.

The binder contained in the positive electrode and the negative electrode has a role of binding the electrode active materials to each other and binding the electrode active material to the collector to prevent the electrode active material from peeling off from the collector. As the binder, a binder in which an aqueous solution of carboxymethyl cellulose (CMC) is used as a thickener and a (meth)acrylic ester-based or styrene-butadiene rubber (SBR)-based aqueous dispersion is used in combination is known.

However, since CMC having low adhesive properties to the electrode active material and the collector is used as the binder, the binding properties between the electrode active materials and the binding properties between the electrode active material and the collector are low. As a result, the battery having a positive electrode and a negative electrode using the binder has a problem that, due to repeated charging and discharging, the electrode active materials and the electrode active material and the collector are likely to be peeled off from each other, and thus capacity reduction is likely to occur.

In order to solve this problem, a method in which a polyacrylate-based aqueous solution or a polyacrylamide-based aqueous solution, which does not require a thickener, is used as a binder is known.

Patent Document 1 discloses a copolymer for a binder for a nonaqueous battery electrode containing a copolymer of N-vinylacetamide and sodium acrylate (copolymerization ratio: N-vinylacetamide, acrylic acid=10/90 mass ratio).

In addition, Patent Document 2 discloses an aqueous solution of a binder for a lithium ion battery containing a copolymer of acrylamide, sodium acrylate, and acrylonitrile (copolymerization ratio: acrylamide, sodium acrylate, acrylonitrile=50/15/35), or a copolymer of acrylamide, acrylic acid, sodium acrylate, acrylonitrile, and 2-hydroxyethyl acrylate copolymer (copolymerization ratio: acrylamide, acrylic acid, sodium acrylate, acrylonitrile, 2-hydroxyethyl acrylate=37/3/10/15/35).

### CITATION LIST

### Patent Documents

Patent Document 1: PCT International Publication No. WO2017/150200
Patent Document 2: Japanese Patent No. 6888656

### SUMMARY OF INVENTION

### Technical Problem

However, in a nonaqueous secondary battery electrode having an electrode active material layer formed using the binder for a nonaqueous secondary battery electrode according to the related art, the electrode active material layer may have insufficient flexibility. In a case where the electrode active material layer of the nonaqueous secondary battery electrode has insufficient flexibility, the yield during the production of nonaqueous secondary batteries is insufficient.

In addition, in the nonaqueous secondary battery according to the related art, it is required to further increase a discharge capacity maintenance rate after a charging and discharging cycle. However, in a nonaqueous secondary battery including a nonaqueous secondary battery electrode formed using the binder for a nonaqueous secondary battery electrode according to the related art, the discharge capacity maintenance rate after a charging and discharging cycle may be insufficient. In particular, in a nonaqueous secondary battery electrode including an electrode active material layer containing silicon or a silicon compound as a negative electrode active material, the electrode active material layer is likely to swell due to charging and discharging of a nonaqueous secondary battery including the nonaqueous secondary battery electrode. This is a problem because the swelling of the electrode active material layer causes a reduction in discharge capacity maintenance rate after the charging and discharging cycle.

The present invention has been made in view of the above-described circumstances, and an object of the present invention is to provide a binder for a nonaqueous secondary battery electrode that can be suitably used as a material of a nonaqueous secondary battery electrode that has an electrode active material layer having good flexibility and makes it possible to obtain a nonaqueous secondary battery having a sufficiently high discharge capacity maintenance rate after a charging and discharging cycle.

Another object of the present invention is to provide a binder composition for a nonaqueous secondary battery electrode and a slurry for a nonaqueous secondary battery electrode containing the binder for a nonaqueous secondary battery electrode according to the present invention.

A further object of the present invention is to provide a nonaqueous secondary battery electrode that has an electrode active material layer containing the binder for a nonaqueous secondary battery electrode according to the present invention and having good flexibility and makes it possible to obtain a nonaqueous secondary battery having a sufficiently high discharge capacity maintenance rate after a charging and discharging cycle, and a nonaqueous secondary battery including the nonaqueous secondary battery electrode.

### Solution to Problem

The present invention includes the following aspects.
[1] A binder for a nonaqueous secondary battery electrode, including:
a copolymer (P) having
a structural unit (a) derived from a monomer (A) represented by General Formula (I), and
a structural unit (b) derived from a monomer (B) represented by General Formula (II) is contained,
in which an amount of the structural unit (a) in the copolymer (P) is 4.0 mol % or more and 75.0 mol % or less, and an amount of the structural unit (b) in the copolymer (P) is 25.0 mol % or more and 96.0 mol % or less.

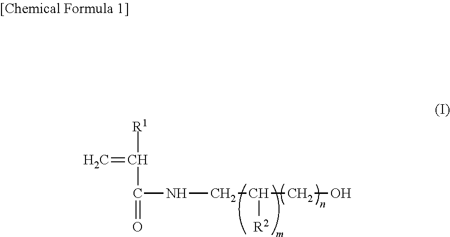

(In Formula (I), R¹ represents a hydrogen atom or a methyl group. R² represents a hydrogen atom or a hydroxy group. m and n each independently represent 0 or 1.)

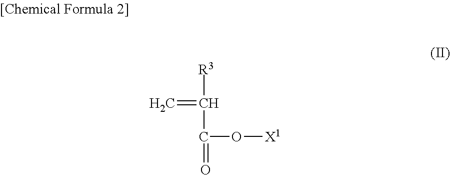

(In Formula (II), R³ represents a hydrogen atom, a methyl group, or CH₂COOX². X¹ and X² each independently represent a hydrogen atom, an alkali metal, or NH₄.)
[2] The binder for a nonaqueous secondary battery electrode according to [1], in which the copolymer (P) has a structural unit (c) derived from a monomer (C) represented by General Formula (III), and
an amount of the structural unit (c) in the copolymer (P) is 0.5 mol % or more and 55.0 mol % or less.

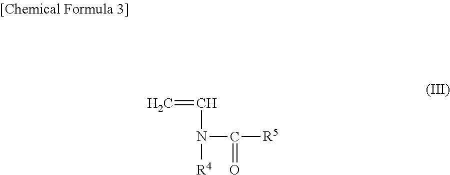

(In Formula (III), R⁴ and R⁵ each independently represent a hydrogen atom or an alkyl group having 1 or more and 5 or less carbon atoms.)
[3] The binder for a nonaqueous secondary battery electrode according to [1] or [2], in which the monomer (A) includes at least any one of N-hydroxyethyl acrylamide or N-methylol acrylamide.
[4] The binder for a nonaqueous secondary battery electrode according to any one of [1] to [3], in which the monomer (B) includes at least any one of sodium (meth)acrylate or lithium (meth)acrylate.
[5] The binder for a nonaqueous secondary battery electrode according to any one of [2] to [4], in which the monomer (C) includes at least any one of N-vinylformamide or N-vinylacetamide.
[6] The binder for a nonaqueous secondary battery electrode according to any one of [1] to [5], in which a weight-average molecular weight of the copolymer (P) is within a range of 300,000 or more and 5,000,000 or less.
[7] The binder for a nonaqueous secondary battery electrode according to any one of [1] to [6], in which a weight-average molecular weight of the copolymer (P) is within a range of 1,500,000 or more and 5,000,000 or less.
[8] The binder for a nonaqueous secondary battery electrode according to [1], in which a sum of the amount of the structural unit (a) and the amount of the structural unit (b) in the copolymer (P) is 55.0 mol % or more.
[9] The binder for a nonaqueous secondary battery electrode according to any one of [1] to [8], that is used for an electrode active material layer containing an electrode active material containing 5 mass % or more of silicon or a silicon compound.
[10] A binder composition for a nonaqueous secondary battery electrode, including: the binder for a nonaqueous secondary battery electrode according to any one of [1] to [9]; and an aqueous medium.
[11] A slurry for a nonaqueous secondary battery electrode, including: the binder for a nonaqueous secondary battery electrode according to any one of [1] to [9]; an electrode active material; and an aqueous medium.
[12] A nonaqueous secondary battery electrode including: a collector; and an electrode active material layer formed on a surface of the collector, in which the electrode active material layer contains the binder for a nonaqueous secondary battery electrode according to any one of [1] to [9] and an electrode active material.
[13] The nonaqueous secondary battery electrode according to [12], in which the electrode active material contains 5 mass % or more of silicon or a silicon compound.
[14] A nonaqueous secondary battery including: the nonaqueous secondary battery electrode according to [12] or [13].

### Advantageous Effects of Invention

According to the present invention, it is possible to provide a binder for a nonaqueous secondary battery electrode that can be suitably used as a material of a nonaqueous secondary battery electrode that has an electrode active material layer having good flexibility and makes it possible to obtain a nonaqueous secondary battery having a sufficiently high discharge capacity maintenance rate after a charging and discharging cycle, and a binder composition for a nonaqueous secondary battery electrode and a slurry for a nonaqueous secondary battery electrode containing the binder for a nonaqueous secondary battery electrode.

In addition, according to the present invention, it is possible to provide a nonaqueous secondary battery electrode that has an electrode active material layer having good flexibility and makes it possible to obtain a nonaqueous secondary battery having a sufficiently high discharge capacity maintenance rate after a charging and discharging cycle, and a nonaqueous secondary battery including the nonaqueous secondary battery electrode.

### DESCRIPTION OF EMBODIMENTS

Hereinafter, a binder for a nonaqueous secondary battery electrode, a binder composition for a nonaqueous secondary battery electrode, a slurry for a nonaqueous secondary battery electrode, a nonaqueous secondary battery electrode, and a nonaqueous secondary battery according to the present invention will be described.

In the present embodiment, the nonaqueous secondary battery (hereinafter, may be referred to as “battery”) involves the movement of ions between a positive electrode and a negative electrode, which are nonaqueous secondary battery electrodes, during charging and discharging. The positive electrode contains a positive electrode active material that is an electrode active material. The negative electrode contains a negative electrode active material that is an electrode active material. These electrode active materials are capable of intercalation and deintercalation of ions. Preferable examples of the nonaqueous secondary battery include lithium ion secondary batteries.

In the present embodiment, the “(meth)acrylic acid” indicates one or both of methacrylic acid and acrylic acid. The “(meth)acrylate” indicates one or both of methacrylate and acrylate.

The “weight-average molecular weight” is a pullulan-equivalent value calculated using gel permeation chromatography (GPC).

### <1. Binder for Nonaqueous Secondary Battery Electrode>

A binder for a nonaqueous secondary battery electrode according to the present embodiment (hereinafter, may be referred to as “electrode binder”) contains a copolymer (P).

The copolymer (P) includes a structural unit (a) represented by General Formula (1) and a structural unit (b) represented by General Formula (2). The copolymer (P) may include, in addition to the structural unit (a) and the structural unit (b), at least one of a structural unit (c) represented by General Formula (3) and a structural unit (d) different from the structural units (a) to (c).

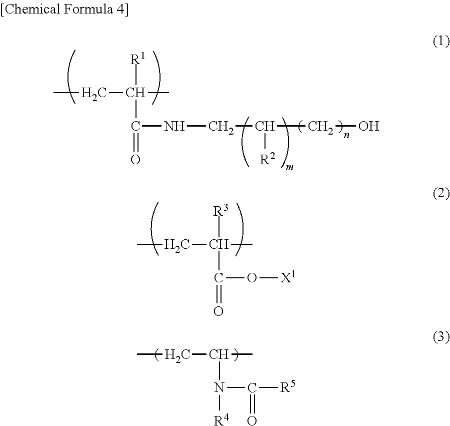

(In Formula (1), R¹ represents a hydrogen atom or a methyl group. R² represents a hydrogen atom or a hydroxy group. m and n each independently represent 0 or 1.)

(In Formula (2), R³ represents a hydrogen atom, a methyl group, or CH₂COOX². X¹ and X² each independently represent a hydrogen atom, an alkali metal, or NH₄.)

(In Formula (3), R⁴ and R⁵ each independently represent a hydrogen atom or an alkyl group having 1 or more and 5 or less carbon atoms.)

The structural unit (a) and the structural unit (b) included in the copolymer (P) are repeating units. The arrangement order of the structural unit (a) and the structural unit (b) included in the copolymer (P) is not particularly limited. The copolymer (P) may be any one of a random copolymer, a block copolymer, or an alternating copolymer including the structural unit (a) and the structural unit (b).

In a case where the copolymer (P) contains not only the structural unit (a) and the structural unit (b) but also at least one of the structural unit (c) and the structural unit (d), the arrangement order of the structural units (a) and (b), which are repeating units, and at least one of the structural units (c) and (d) is not particularly limited.

<1-1. Structural Unit (a)>

The structural unit (a) represented by General Formula (1) is a structural unit derived from a monomer (A) represented by General Formula (I). The monomer (A) may be only one kind of compound, or may be a plurality of kinds of compounds. The structural unit (a) contributes to an improvement in flexibility of an electrode active material layer containing the electrode binder containing the copolymer (P), and also contributes to an improvement in discharge capacity maintenance rate after a charging and discharging cycle in a battery including a nonaqueous secondary battery electrode having the electrode active material layer.

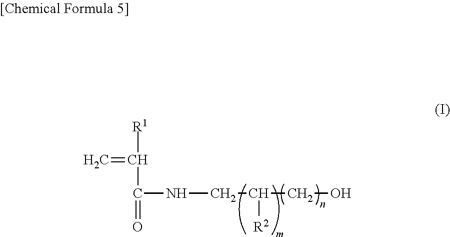

(In Formula (I), R¹ represents a hydrogen atom or a methyl group. R² represents a hydrogen atom or a hydroxy group. m and n each independently represent 0 or 1.)

R¹, R², m, and n in Formula (I) are the same as R¹, R², m, and n in Formula (1).

In Formula (I), R¹ represents a hydrogen atom or a methyl group, and is preferably a hydrogen atom since a material of a nonaqueous secondary battery electrode that makes it possible to obtain a nonaqueous secondary battery having a higher discharge capacity maintenance rate after a charging and discharging cycle is obtained.

In Formula (I), m is 0 or 1, and is preferably 0 since it is possible to obtain a nonaqueous secondary battery electrode having a high solubility parameter (SP value) and better resistance (stability) to an electrolytic solution contained in a battery. In a case where m is 1, R² represents a hydrogen atom or a hydroxy group.

In Formula (I), n is 0 or 1, and is preferably 1. This is because a material of a nonaqueous secondary battery electrode that makes it possible to obtain a nonaqueous secondary battery, in which an electrode active material layer containing the electrode binder containing the copolymer (P) has improved flexibility and which has a higher discharge capacity maintenance rate after a charging and discharging cycle, is obtained.

Specific examples of the monomer (A) include the following compounds (R¹, R², m, and n in the brackets correspond to R¹, R², m, and n in Formula (I)): N-methylol acrylamide ((N-MAM), R¹: hydrogen atom, m: 0, n: 0), N-hydroxyethyl acrylamide ((HEAA), R¹: hydrogen atom, m: 0, n: 1), N-hydroxypropyl acrylamide (R¹: hydrogen atom, R²: hydrogen atom, m: 1, n: 1), and N-(2,3-dihydroxypropyl)acrylamide (R¹: hydrogen atom, R²: hydroxy group, m: 1, n: 1).

Among these, at least any one of N-hydroxyethyl acrylamide or N-methylol acrylamide is preferably included as the monomer (A). This is because a material of a nonaqueous secondary battery electrode that makes it possible to obtain a nonaqueous secondary battery having a higher discharge capacity maintenance rate after a charging and discharging cycle is obtained. N-hydroxyethyl acrylamide is particularly preferably included as the monomer (A). This is because a material of a nonaqueous secondary battery electrode that makes it possible to obtain a nonaqueous secondary battery, in which an electrode active material layer containing the electrode binder containing the copolymer (P) has improved flexibility and which has a further higher discharge capacity maintenance rate after a charging and discharging cycle, is obtained.

The reason is not clear why, in a case where the copolymer (P) includes the structural unit (a) represented by General Formula (1), a battery in which a nonaqueous secondary battery electrode including an electrode active material layer containing the electrode binder containing the copolymer (P) has a sufficiently high discharge capacity maintenance rate after a charging and discharging cycle is obtained. However, the present inventors presume that the reason for this is due to the following functions obtained by including the structural unit (a).

That is, in a case where the electrode binder contains the copolymer (P) including the structural unit (a) having an amide bond and a hydroxy group, an electrode active material layer having good resistance to an electrolytic solution contained in a battery is obtained, compared to, for example, a case where a copolymer including a structural unit having an ester bond (—C(═O)O—) is contained. Therefore, the electrode active material layer containing the electrode binder containing the copolymer (P) is less likely to be destroyed even in a case where a stress is applied due to battery charging and discharging, and the swelling of the electrode due to the battery charging and discharging is suppressed.

Moreover, since the copolymer (P) includes the structural unit (a) having an amide bond and a hydroxy group, an electrode active material layer containing the electrode binder containing the copolymer (P) has good binding properties between the electrode active material particles and between the electrode active material particles and the collector.

Therefore, it is presumed that a battery having a nonaqueous secondary battery electrode including the electrode active material layer containing the electrode binder containing the copolymer (P) is less likely to deteriorate due to charging and discharging, and has a sufficiently high discharge capacity maintenance rate after a charging and discharging cycle.

<1-2. Structural Unit (b)>

The structural unit (b) represented by General Formula (2) is a structural unit derived from a monomer (B) represented by General Formula (II). The monomer (B) may be only one kind of compound, or may be a plurality of kinds of compounds.

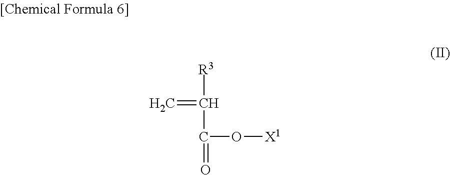

(In Formula (II), R³ represents a hydrogen atom, a methyl group, or CH₂COOX². X¹ and X² each independently represent a hydrogen atom, an alkali metal, or NH₄.)

R³, X¹, and X² in Formula (II) are the same as R³, X¹, and X² in Formula (2).

In Formula (II), R³ represents a hydrogen atom, a methyl group, or CH₂COOX², and is preferably a hydrogen atom or a methyl group, and more preferably a hydrogen atom since a material of a nonaqueous secondary battery electrode that makes it possible to obtain a nonaqueous secondary battery having a higher discharge capacity maintenance rate after a charging and discharging cycle is obtained. In a case where R³ is CH₂COOX², X² is a hydrogen atom, an alkali metal, or NH₄, and is preferably an alkali metal or NH₄. This is because a material of a nonaqueous secondary battery electrode that makes it possible to obtain a nonaqueous secondary battery having a higher discharge capacity maintenance rate after a charging and discharging cycle is obtained.

X¹ represents a hydrogen atom, an alkali metal, or NH₄, and is preferably an alkali metal or NH₄. This is because a material of a nonaqueous secondary battery electrode that makes it possible to obtain a nonaqueous secondary battery having a higher discharge capacity maintenance rate after a charging and discharging cycle is obtained.

In a case where at least one of X¹ and X² in Formula (II) is an alkali metal, examples of the alkali metal include lithium, sodium, and potassium. Specific examples of the preferable monovalent cation corresponding to at least one of X¹ and X² include a lithium ion, a sodium ion, a potassium ion, and an ammonium ion. This is because the monomer represented by Formula (II) in which at least one of X¹ and X² is one of these is easily available. Among these monovalent cations, at least one of a lithium ion and a sodium ion is preferably included, and a sodium ion is more preferably included. This is because a copolymer (P) with better adhesive strength to an electrode active material is obtained, and a battery having a nonaqueous secondary battery electrode including an electrode active material layer containing an electrode binder containing the copolymer (P) has a higher discharge capacity maintenance rate after a charging and discharging cycle.

Specific examples of the monomer (B) include the following compounds (R³, X¹, and X² in the brackets correspond to R³, X¹, and X² in Formula (II)): an acrylic acid ((Aa), R³: hydrogen atom, X¹: hydrogen atom), a methacrylic acid ((MAa), R³: methyl group, X¹: hydrogen atom), an itaconic acid (R³: CH₂COOX², X¹: hydrogen atom, X²: hydrogen atom), and salts thereof (a compound in which at least one of X¹ and X² in Formula (II) is an alkali metal or NH₄).

Among these, as the monomer (B), at least any one of an acrylate or a methacrylate is preferably included, and at least any one of a sodium acrylate, a lithium acrylate, a sodium methacrylate, or a lithium methacrylate is more preferably included. This is because a material of a nonaqueous secondary battery electrode that makes it possible to obtain a nonaqueous secondary battery having a higher discharge capacity maintenance rate after a charging and discharging cycle is obtained. A sodium acrylate is particularly preferably included as the monomer (B). This is because a material of a nonaqueous secondary battery electrode that makes it possible to obtain a nonaqueous secondary battery having a further higher discharge capacity maintenance rate after a charging and discharging cycle is obtained.

The monomer (B) in which at least one of X¹ and X² in Formula (II) is an alkali metal or NH₄ can be produced by, for example, a method of neutralizing a compound in which at least one of X¹ and X² in Formula (II) is a hydrogen atom with at least one of a hydroxide and aqueous ammonia to convert a part of a carboxy group (—COOH) into a salt.

Therefore, in a case where a copolymer (P) is synthesized in which at least one of X¹ and X² in Formula (2) in the structural unit (b) derived from the monomer (B) is an alkali metal or NH₄, for example, a first method and a second method shown below can be used. Among these, the first method is preferably used since the molecular weight of the copolymer (P) to be produced is easily increased.

In the first method, first, a compound in which at least one of X¹ and X² in Formula (II) is a hydrogen atom is prepared and neutralized with a known neutralizing agent. In this manner, a compound in which at least one of X¹ and X² in Formula (II) is an alkali metal or NH₄ is obtained. Thereafter, monomers including a compound in which at least one of X¹ and X² in Formula (II) is an alkali metal or NH₄ as the monomer (B) and the monomer (A) represented by Formula (I) is copolymerized. In this manner, it is possible to synthesize a copolymer (P) including the structural unit (a) represented by Formula (1) and the structural unit (b) represented by Formula (2) in which X¹ and X² in Formula (2) are at least one of alkali metals or NH₄.

In the second method, a compound in which at least one of X¹ and X² in Formula (II) is a hydrogen atom is used as the monomer (B), and monomers including the monomer (A) and the monomer (B) are copolymerized. Thereafter, the obtained copolymer is neutralized using a known neutralizing agent. In this manner, it is possible to synthesize a copolymer (P) including the structural unit (a) represented by Formula (1) and the structural unit (b) represented by Formula (2) in which at least one of X¹ and X² in Formula (2) is an alkali metal or NH₄.

In a case where X¹ and X² in the structural unit (b) represented by General Formula (2) are an alkali metal or NH₄, X¹ and X² are preferably the same alkali metal or NH₄. This is because, by performing the step of neutralizing the compound in which X¹ and X² in Formula (II) are hydrogen atoms in the above-described first method, or performing the step of neutralizing the copolymer obtained by copolymerizing the monomers including the compound in which X¹ and X² in Formula (II) are hydrogen atoms in the above-described second method, a copolymer (P) including the structural unit (b) in which X¹ and X² in Formula (2) are the same alkali metal or NH₄ can be easily obtained.

In the present embodiment, for example, in a case where a copolymer (P) including a structural unit (b) in which at least one of X¹ and X² in Formula (2) is an alkali metal or NH₄ is produced by the above-described first method or second method, it is considered that a structural unit (b) derived from a salt of the monomer (B) is formed in an amount corresponding to the equivalent of the cations contained in the neutralizing agent (valence of cations×number of moles of cations, the same applies hereinafter) in the structural unit (b) derived from the monomer (B) contained in the copolymer (P).

In a case where the cations contained in the neutralizing agent are divalent or higher, it is considered that one cation is bonded to at least one of X¹ and X² in the monomers (B) of the same number as the valence of the cation, and thus a structural unit (b) derived from a salt of the monomer (B) is formed.

Therefore, in a case where the equivalent of the cations contained in the neutralizing agent is larger than a total number of moles of X¹ and X² contained in the compound in which at least one of X¹ and X² in the monomer (B) represented by Formula (II) used for producing the copolymer (P) is a hydrogen atom, it is considered that all of X¹ and X² in the structural unit (b) derived from the monomer (B) contained in the copolymer (P) obtained after neutralization are alkali metals or NH₄, and all of the structural units (b) contained in the copolymer (P) are derived from the salt of the monomer (B).

Meanwhile, in a case where the equivalent of the cations contained in the neutralizing agent is smaller than the total number of moles of X¹ and X² contained in the compound in which at least one of X¹ and X² in the monomer (B) represented by Formula (II) used for producing the copolymer (P) is a hydrogen atom, it is considered that all of the cations contained in the neutralizing agent form the salt of the structural unit (b) derived from the monomer (B) contained in the copolymer (P) obtained after neutralization. Therefore, it is considered that a structural unit derived from the salt is formed in an amount corresponding to the equivalent of the cations contained in the neutralizing agent, in the structural units (b) derived from the monomer (B).

Specifically, for example, in a case where the copolymer (P) is produced by a method including copolymerizing monomers including a (meth)acrylic acid and the monomer (A) with the use of the (meth)acrylic acid as the monomer (B) and neutralizing the resulting copolymer using a neutralizing agent, it is considered that a structural unit (b) derived from a salt of the (meth)acrylic acid is formed in an amount corresponding to the equivalent of the cations contained in the neutralizing agent (valence of cations×number of moles of cations, the same applies hereinafter) in the structural unit (b) derived from the monomer (B) contained in the copolymer (P) obtained after neutralization.

The structural units (b) derived from the monomer (B) preferably includes 60 mol % or more of the structural unit (b) derived from the compound in which at least one of X¹ and X² in the monomer (B) represented by Formula (II) is an alkali metal or NH₄, more preferably 80 mol % or more, still more preferably 95 mol % or more, and may be up to 100 mol %. This is because a copolymer (P) with better adhesive strength to an electrode active material is obtained, and a battery having a nonaqueous secondary battery electrode including an electrode active material layer containing an electrode binder containing the copolymer (P) has a higher discharge capacity maintenance rate after a charging and discharging cycle.

The reason is not clear why, in a case where the copolymer (P) includes the structural unit (b) represented by General Formula (2), a battery in which a nonaqueous secondary battery electrode including an electrode active material layer containing the electrode binder containing the copolymer (P) has a sufficiently high discharge capacity maintenance rate after a charging and discharging cycle is obtained. However, the present inventors presume that the reason for this is due to the following functions obtained by including the structural unit (b).

That is, (i) in a case where the electrode binder contains the copolymer (P) including the structural unit (b) having at least one of a carboxy group and a carboxylate, resistance to an electrolytic solution contained in a battery is improved, for example, compared to a case where a copolymer including a structural unit having an ester bond (—C(═O)O—) instead of the structural unit (b) is contained. Therefore, the electrode active material layer containing the electrode binder containing the copolymer (P) can suppress the swelling of the electrode due to the swelling of the electrode binder in contact with the electrolytic solution.

Furthermore, (ii) since the copolymer (P) includes the structural unit (b) having at least one of a carboxy group and a carboxylic acid, the dispersibility of the solid content of the electrode active material, conductive assistant, and the like is improved in a slurry for a nonaqueous secondary battery electrode containing the electrode binder containing the copolymer (P). Therefore, the solid content aggregation is suppressed, and thus an electrode active material layer with uniformly dispersed solid content is easily formed. Therefore, in a case where a battery having the nonaqueous secondary battery electrode including the electrode active material layer is charged and discharged, a local deviation in potential is less likely to occur in the electrode active material layer, and excessive decomposition of the electrolytic solution due to charging and discharging can be suppressed.

Moreover, (iii) since the copolymer (P) includes the structural unit (b) having at least one of a carboxy group and a carboxylic acid, the electrode active material layer containing the electrode binder containing the copolymer (P) has good binding properties between the electrode active material particles and between the electrode active material particles and the collector.

It is presumed that, through the functions due to the inclusion of the structural unit (b) in (i) to (iii), a battery having a nonaqueous secondary battery electrode including the electrode active material layer containing the electrode binder containing the copolymer (P) is less likely to deteriorate due to charging and discharging, and has a sufficiently high discharge capacity maintenance rate after a charging and discharging cycle.

<1-3. Structural Unit (c)>

The structural unit (c) represented by General Formula (3) is a structural unit derived from a monomer (C) represented by General Formula (III). The monomer (C) may be only one kind of compound, or may be a plurality of kinds of compounds. The structural unit (c) contributes to an improvement in dispersibility of the solid content of the electrode active material, conductive assistant, and the like in a slurry for a nonaqueous secondary battery electrode containing the electrode binder containing the copolymer (P).

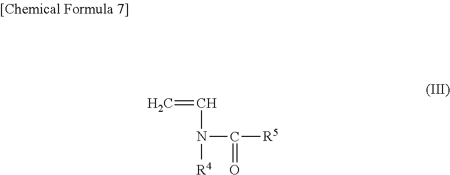

(In Formula (III), R⁴ and R⁵ each independently represent a hydrogen atom or an alkyl group having 1 or more and 5 or less carbon atoms.)

R⁴ and R⁵ in Formula (III) are the same as R⁴ and R⁵ in Formula (3).

In Formula (III), R⁴ and R⁵ each independently represent a hydrogen atom or an alkyl group having 1 or more and 5 or less carbon atoms, and a hydrogen atom or an alkyl group having 1 or more and 3 or less carbon atoms is preferable. R⁴ is preferably a hydrogen atom or a methyl group, and more preferably a hydrogen atom. This is because, in a slurry for a nonaqueous secondary battery electrode containing the electrode binder containing the copolymer (P), the dispersibility of the solid content of the electrode active material, conductive assistant, and the like is improved. R⁵ is preferably a hydrogen atom or a methyl group, and more preferably a methyl group. This is because, in a slurry for a nonaqueous secondary battery electrode containing the electrode binder containing the copolymer (P), the dispersibility of the solid content of the electrode active material, conductive assistant, and the like is improved.

Specific examples of the monomer (C) include the following compounds (R⁴ and R⁵ in the brackets correspond to R⁴ and R⁵ in Formula (III)): N-vinylformamide (R⁴: hydrogen atom, R⁵: hydrogen atom) and N-vinylacetamide (R⁴: hydrogen atom, R⁵: methyl group). Among these, N-vinylacetamide is preferable as the monomer (C) since the dispersibility of the solid content of the electrode active material, conductive assistant, and the like is improved in a slurry for a nonaqueous secondary battery electrode containing the electrode binder containing the copolymer (P).

<1-4. Structural Unit (d)>

The copolymer (P) may include, in addition to the structural unit (a), the structural unit (b), and the structural unit (c) that may be contained as necessary, the structural unit (d) different from the structural units (a) to (c), within a range not impairing the effects of the present invention.

The structural unit (d) is a structural unit derived from a monomer (D) that does not fall under any one of the monomer (A), the monomer (B), or the monomer (C). For example, a (meth)acrylic acid, an itaconic acid, and salts thereof, which are ethylenically unsaturated monomers having a carboxy group, fall under the monomer (B). The monomer (D) may be only one kind of compound, or may be a plurality of kinds of compounds.

The monomer (D) may be a polymerizable compound that does not fall under any one of the monomer (A), the monomer (B), or the monomer (C). Examples thereof include a hydrophilic ethylenically unsaturated compound and a hydrophobic ethylenically unsaturated compound, and a hydrophilic ethylenically unsaturated compound is preferably contained.

Examples of the hydrophilic ethylenically unsaturated monomer include a compound having at least one polymerizable ethylenically unsaturated bond and having at least one of a polar group such as a hydroxy group, a carboxy group, or a cyano group and an amide bond.

Examples of the ethylenically unsaturated monomer having an amide bond include (meth)acrylamide, N-alkyl (meth)acrylamide, N,N-dialkyl (meth)acrylamide, diacetone (meth)acrylamide, dimethylaminoalkyl (meth)acrylamide in which the number of carbon atoms of an alkyl group of a portion excluding a dimethylamino group is 1 to 5, and (meth)acrylamide-2-methylpropane sulfonic acid. Among these, (meth)acrylamide is preferable as the ethylenically unsaturated monomer having an amide bond since it is possible to obtain a copolymer (P) having good resistance to an electrolytic solution contained in a battery.

Examples of the ethylenically unsaturated monomer having a hydroxy group include 2-hydroxyethyl (meth)acrylate, 2-hydroxypropyl (meth)acrylate, 4-hydroxybutyl acrylate, and 1,4-cyclohexanedimethanol monoacrylate. Among these, 2-hydroxyethyl (meth)acrylate is preferable as the ethylenically unsaturated monomer having a hydroxy group since an electrode active material layer containing the electrode binder containing the copolymer (P) has good flexibility.

Examples of the ethylenically unsaturated monomer having a carboxy group include β-carboxyethyl acrylate, maleic acid, fumaric acid, crotonic acid, and half esters of unsaturated dicarboxylic acid.

Examples of the ethylenically unsaturated monomer having a cyano group include (meth)acrylonitrile.

### <1-5. Amount of Each Structural Unit in Copolymer (P)>

Next, the amount of each of the structural units (a) to (d) included in the copolymer (P) will be described.

In the present embodiment, the amount of the structural unit derived from each monomer contained in the copolymer (P) can be calculated using the amount of each monomer used for producing the copolymer (P). Hereinafter, the amount of the structural unit derived from each monomer in the copolymer (P) will be described using the amount of each monomer, that is, the value in mol % in a case where the total of the monomers from which the structural units in the copolymer (P) are derived is defined as 100 mol %.

In a case where a compound other than monomers, such as a chain transfer agent, is used in the polymerization of the copolymer (P), a structural unit derived from the compound other than monomers is also considered for the structure of the copolymer (P).

In addition, for example, in a case where a copolymer (P) including a structural unit (b) in which at least one of X¹ and X² in Formula (2) is an alkali metal or NH₄ is produced by the above-described first method or second method, it is considered that a structural unit (b) derived from a salt of the monomer (B) is formed in an amount corresponding to the equivalent of the cations contained in the neutralizing agent (valence of cations×number of moles of cations, the same applies hereinafter) in the structural unit (b) derived from the monomer (B) contained in the copolymer (P).

### (Amount of Structural Unit (a))

The amount of the structural unit (a) in the copolymer (P) is 4.0 mol % or more. This is because an electrode active material layer containing the electrode binder containing the copolymer (P) has good flexibility and the occurrence of cracks can be suppressed in the electrode active material layer. In addition, this is because a battery having a nonaqueous secondary battery electrode including an electrode active material layer containing the copolymer (P) has a high discharge capacity maintenance rate after a charging and discharging cycle. The amount of the structural unit (a) is preferably 15.0 mol % or more, more preferably 35 mol % or more, and still more preferably 40.0 mol % or more, since the above-described effects due to the inclusion of the structural unit (a) are more remarkably exhibited.

The amount of the structural unit (a) is 75.0 mol % or less. This is because the solid content included in the electrode active material, conductive assistant, electrode binder, and the like is more uniformly present in a slurry for a nonaqueous secondary battery electrode containing the electrode binder containing the copolymer (P). In addition, this is because a battery having a nonaqueous secondary battery electrode including an electrode active material layer containing the copolymer (P) has a high discharge capacity maintenance rate after a charging and discharging cycle. Due to the above-described reasons, the amount of the structural unit (a) is preferably 65.0 mol % or less, more preferably 60.0 mol % or less, and still more preferably 55.0 mol % or less.

### (Amount of Structural Unit (b))

The amount of the structural unit (b) in the copolymer (P) is 25.0 mol % or more. This is because the solid content included in the electrode active material, conductive assistant, electrode binder, and the like is more uniformly present in a slurry for a nonaqueous secondary battery electrode containing the electrode binder containing the copolymer (P). In addition, this is because a battery having a nonaqueous secondary battery electrode including an electrode active material layer containing the copolymer (P) has a high discharge capacity maintenance rate after a charging and discharging cycle. The amount of the structural unit (b) is preferably 30.0 mol % or more, more preferably 40.0 mol % or more, and still more preferably 45.0 mol % or more, since the above-described effects due to the inclusion of the structural unit (b) are more remarkably exhibited.

The amount of the structural unit (b) is 96.0 mol % or less. This is because an electrode active material layer containing the electrode binder containing the copolymer (P) has good flexibility and the occurrence of cracks can be suppressed in the electrode active material layer. Due to the above-described reasons, the amount of the structural unit (b) is preferably 85.0 mol % or less, more preferably 65.0 mol % or less, and still more preferably 60.0 mol % or less.

### (Sum of Amount of Structural Unit (a) and Amount of Structural Unit (b))

The sum of the amount of the structural unit (a) and the amount of the structural unit (b) in the copolymer (P) is preferably 55.0 mol % or more. This is because it is possible to obtain an electrode binder capable of forming a nonaqueous secondary battery electrode that has an electrode active material layer having good flexibility and makes it possible to obtain a battery having a higher discharge capacity maintenance rate after a charging and discharging cycle. In particular, it is preferable that the above-described sum is 55.0 mol % or more, since it is possible to form a nonaqueous secondary battery electrode that has an electrode active material layer having good flexibility and makes it possible to obtain a battery having a sufficiently high discharge capacity maintenance rate after a charging and discharging cycle even in a case where the electrode active material layer contains silicon or a silicon compound.

The sum of the amount of the structural unit (a) and the amount of the structural unit (b) is more preferably 60.0 mol % or more, and still more preferably 65.0 mol % or more. The sum of the amount of the structural unit (a) and the sum of the structural unit (b) may be 70.0 mol % or more.

The above-described sum may be 100 mol %. That is, the copolymer (P) may be a binary copolymer formed of only the structural unit (a) and the structural unit (b). In a case where the structural units included in the copolymer (P) are only the structural unit (a) and the structural unit (b) (in other words, the above-described sum is 100 mol %), the copolymer (P) can be easily produced.

### (Amount of Structural Unit (c))

The amount of the structural unit (c) in the copolymer (P) is preferably 0.5 mol % or more, more preferably 0.8 mol % or more, and still more preferably 1.0 mol % or more. This is because the dispersibility of the solid content of the electrode active material, conductive assistant, and the like is improved in a slurry for a nonaqueous secondary battery electrode containing an electrode binder containing the copolymer (P), the solid content aggregation is suppressed, and thus an electrode active material layer with uniformly dispersed solid content is easily formed.

The amount of the structural unit (c) is preferably 55.0 mol % or less, more preferably 50.0 mol % or less, and still more preferably 45.0 mol % or less. This is because an electrode active material layer containing an electrode binder containing a copolymer (P) in which the amount of the structural unit (c) is 55.0 mol % or less has improved flexibility and is less likely to be cracked.

### (Amount of Structural Unit (d))

The amount of the structural unit (d) in the copolymer (P) is preferably 40.0 mol % or less, and more preferably 35.0 mol % or less, and may be 3.0 mol % or less or 0 mol %. In a case where the structural unit (d) is a structural unit derived from an ethylenically unsaturated monomer having an amide bond, particularly (meth)acrylamide, the amount of the structural unit (d) is preferably more than 0 mol %, and may be 5.0 mol % or more or 10.0 mol % or more. This is because it is possible to obtain a copolymer (P) having good resistance to an electrolytic solution contained in a battery.

In a case where the structural unit (d) is a structural unit derived from an ethylenically unsaturated monomer having an amide bond, particularly (meth)acrylamide, the amount of the structural unit (d) is preferably 40.0 mol % or less, more preferably 35.0 mol % or less, and still more preferably 33.0 mol % or less. This is because the copolymer (P) has excellent wettability with respect to the electrode active material and has improved adhesive strength with respect to the electrode active material. In addition, this is because excessive decomposition of the electrolytic solution due to charging and discharging is suppressed in a battery having a nonaqueous secondary battery electrode including an electrode active material layer containing the copolymer (P). In a case where the structural unit (d) is a structural unit derived from an ethylenically unsaturated monomer having an amide bond, particularly (meth)acrylamide, the amount of the structural unit (d) may be 0 mol %. This is because, in this case, the copolymer (P) has excellent wettability with respect to the electrode active material and has improved adhesive strength with respect to the electrode active material. In addition, this is because excessive decomposition of the electrolytic solution due to charging and discharging is further suppressed in a battery having a nonaqueous secondary battery electrode including an electrode active material layer containing the copolymer (P).

### <1-6. Weight-Average Molecular Weight of Copolymer (P)>

The weight-average molecular weight of the copolymer (P) is preferably 300,000 or more, more preferably 700,000 or more, and still more preferably 1,000,000 or more. The weight-average molecular weight of the copolymer (P) may be 1,500,000 or more or 2,000,000 or more. This is because the binding properties between the electrode active materials and between the electrode active material and the collector are improved in an electrode active material layer containing the electrode binder containing the copolymer (P). As a result, a battery having a nonaqueous secondary battery electrode including the electrode active material layer containing the copolymer (P) has a higher discharge capacity maintenance rate after a charging and discharging cycle.

The weight-average molecular weight of the copolymer (P) is preferably 5,000,000 or less, more preferably 4,000,000 or less, and still more preferably 3,500,000 or less. The weight-average molecular weight of the copolymer (P) may be 3,000,000 or less. This is because the copolymer (P) is easily produced. In addition, this is because the viscosity of a slurry for a nonaqueous secondary battery electrode containing the electrode binder containing the copolymer (P) is easily adjusted, and the dispersibility of the solid content of the electrode active material, conductive assistant, and the like and the productivity of the electrode active material layer are improved.

### <1-7. Method of Producing Copolymer (P)>

The copolymer (P) is preferably produced by a method of copolymerizing monomers including the monomer (A) and the monomer (B) in an aqueous medium containing a radical polymerization initiator using a radical polymerization method.

As the radical polymerization method, for example, a method in which all monomers to be used for producing the copolymer (P) are collectively added and polymerized, a method in which monomers to be used for producing the copolymer (P) are polymerized while being continuously supplied, or the like can be applied.

The amount of each monomer in all the monomers used for producing the copolymer (P) is regarded as the amount of the structural unit corresponding to the monomer in the copolymer (P). For example, the amount of the monomer (A) in all the monomers used for producing the copolymer (P) is the amount of the structural unit (a) in the synthesized copolymer (P).

In addition, in the present embodiment, for example, in a case where a copolymer (P) including a structural unit (b) in which X¹ and/or X² in Formula (2) are/is an alkali metal or NH₄ is produced by the above-described first method or second method, it is considered that a structural unit (b) derived from a salt of the monomer (B) is formed in an amount corresponding to the equivalent of the cations contained in the neutralizing agent (valence of cations×number of moles of cations, the same applies hereinafter) in the structural unit (b) derived from the monomer (B) contained in the copolymer (P).

Therefore, in a case where the equivalent of the cations contained in the neutralizing agent is larger than a total number of moles of X¹ and X² contained in the compound in which at least one of X¹ and X² in the monomer (B) represented by Formula (II) used for producing the copolymer (P) is a hydrogen atom, it is considered that all of X¹ and X² in the structural unit (b) derived from the monomer (B) contained in the copolymer (P) obtained after neutralization are alkali metals or NH₄, and all of the structural units (b) contained in the copolymer (P) are derived from the salt of the monomer (B).

Meanwhile, in a case where the equivalent of the cations contained in the neutralizing agent is smaller than the total number of moles of X¹ and X² contained in the compound in which at least one of X¹ and X² in the monomer (B) represented by Formula (II) used to produce the copolymer (P) is a hydrogen atom, it is considered that all of the cations contained in the neutralizing agent form the salt of the structural unit (b) derived from the monomer (B) contained in the copolymer (P) obtained after neutralization. Therefore, it is considered that a structural unit derived from the salt is formed in an amount corresponding to the equivalent of the cations contained in the neutralizing agent, in the structural units (b) derived from the monomer (B).

In the production of the copolymer (P), for example, ammonium persulfate, potassium persulfate, sodium persulfate, hydrogen peroxide, t-butyl hydroperoxide, an azo compound, or the like can be used as the radical polymerization initiator. Examples of the azo compound include 2,2′-azobis(2-methylpropionamidine) dihydrochloride. In a case where the copolymer (P) is produced by a method of performing radical polymerization in an aqueous medium, a water-soluble compound is preferably used as the radical polymerization initiator. In addition, in the polymerization of the copolymer (P), the radical polymerization initiator may be used in combination with a reducing agent for redox polymerization as necessary. Examples of the reducing agent used for redox polymerization include sodium bisulfite, Rongalite, and ascorbic acid.

As the aqueous medium used in the production of the copolymer (P), water is preferably used. A mixture obtained by adding a hydrophilic solvent to water may be used as the aqueous medium as long as the polymerization stability of the copolymer (P) is not impaired. Examples of the hydrophilic solvent to be added to water include methanol, ethanol, and N-methylpyrrolidone.

The radical polymerization for producing the copolymer (P) is preferably performed at a temperature of 30° C. to 90° C.

In the polymerization for producing the copolymer (P), a chain transfer agent may be used to adjust the molecular weight of the copolymer (P). The chain transfer agent is not particularly limited, and examples thereof include known agents such as β-mercaptopropionic acid, thiols such as octyl thioglycolate, alcohols such as isopropyl alcohol and ethanol, halogenated hydrocarbons such as carbon tetrabromide and carbon tetrachloride, and α-methylstyrene dimer.

The amount of these chain transfer agents used is not particularly limited, and a known amount may be selected. The amount of the chain transfer agent used is, for example, preferably 10 mol % or less with respect to the total number of moles of the monomers and compounds used for producing the copolymer (P).

The electrode binder according to the present embodiment may contain a component other than the copolymer (P). Examples of the component include at least one of a polymer other than the copolymer (P) and a surfactant. In a case where the electrode binder according to the present embodiment contains a component other than the copolymer (P), the electrode binder can be produced by a method of mixing the copolymer (P) and the component using a known method.

Examples of the polymer other than the copolymer (P) include water-soluble polymers such as poly(meth)acrylate, poly(meth)acrylamide, carboxymethyl cellulose salt, and polyvinyl alcohol, and emulsion type polymers such as polystyrene-(meth)acrylic ester copolymer and polystyrene-butadiene copolymer.

Examples of the surfactant include anionic surfactants such as alkylbenzene sulfonate, alkyl sulfate ester salt, polyoxyethylene alkyl ether sulfate salt, and fatty acid salt, and nonionic surfactants such as polyoxyethylene alkyl ether, polyoxyethylene alkyl phenyl ether, polyoxyethylene polycyclic phenyl ether, polyoxyalkylene alkyl ether, sorbitan fatty acid ester, and polyoxyethylene sorbitan fatty acid ester.

In a case where the electrode binder according to the present embodiment contains a component other than the copolymer (P), the amount of the copolymer (P) in the electrode binder is preferably 80 mass % or more, more preferably 90 mass % or more, still more preferably 95 mass % or more, and particularly preferably 98 mass % or more. This is because the contribution to the intended effects of the present invention is increased by containing the copolymer (P).

### <2. Binder Composition for Nonaqueous Secondary Battery Electrode>

A binder composition for a nonaqueous secondary battery electrode according to the present embodiment (hereinafter, may be referred to as “electrode binder composition”) contains an electrode binder and an aqueous medium.

The aqueous medium contained in the electrode binder composition contains water. The aqueous medium contained in the electrode binder composition may contain a hydrophilic solvent other than water. Examples of the hydrophilic solvent include methanol, ethanol, and N-methylpyrrolidone. The amount of the water in the aqueous medium contained in the electrode binder composition is preferably 80 mass % or more, more preferably 90 mass % more, and still more preferably 95 mass % or more, and may be 100 mass %.

The aqueous medium contained in the electrode binder composition may be, for example, the same as the aqueous medium used for synthesis of the copolymer (P), or may be obtained by further adding a solvent such as water to the aqueous medium used for synthesis of the copolymer (P).

In addition, the electrode binder contained in the electrode binder composition according to the present embodiment may be dissolved or dispersed in the aqueous medium.

The amount of the electrode binder in the electrode binder composition is preferably 30 mass % or less, and more preferably 20 mass % or less. This is because the electrode binder composition is less likely to have too high viscosity and imparted with appropriate viscosity. In a case where the electrode binder composition has appropriate viscosity, in the preparation of a slurry for a nonaqueous secondary battery electrode by mixing with an electrode active material and the like to be described later, the electrode active material and the like can be efficiently dispersed.

The amount of the electrode binder in the electrode binder composition is preferably 3.0 mass % or more, more preferably 5.0 mass % or more, and still more preferably 8.0 mass % or more. This is because the amount of the electrode binder composition used can be suppressed in a case where a slurry for a nonaqueous secondary battery electrode and a nonaqueous secondary battery electrode are prepared using the electrode binder composition.

The pH of the electrode binder composition is preferably 4.0 or higher, more preferably 5.0 or higher, and still more preferably 6.0 or higher. This is because, in a case where a slurry for a nonaqueous secondary battery electrode is prepared by mixing the electrode binder composition with an electrode active material and the like to be described later, the electrode active material and the like can be efficiently dispersed.

The pH of the electrode binder composition is preferably 11 or lower, more preferably 10 or lower, and still more preferably 9.0 or lower. This is because, in a case where a slurry for a nonaqueous secondary battery electrode is prepared by mixing the electrode binder composition with an electrode active material and the like to be described later, the electrode active material and the like can be efficiently dispersed.

The pH of the electrode binder composition is a value measured with a pH meter at a liquid temperature of 23° C.

The electrode binder composition according to the present embodiment may contain a component other than the electrode binder and the aqueous medium as necessary. Examples of the component include a pH adjuster and a surfactant.

Examples of the pH adjuster include hydroxides of alkali metals such as lithium hydroxide, sodium hydroxide, and potassium hydroxide, amines such as ethanolamine, triethanolamine, and ethylenediamine, and ammonia.

Examples of the surfactant include anionic surfactants such as alkylbenzene sulfonate, alkyl sulfate ester salt, polyoxyethylene alkyl ether sulfate salt, and fatty acid salt, and nonionic surfactants such as polyoxyethylene alkyl ether, polyoxyethylene alkyl phenyl ether, polyoxyethylene polycyclic phenyl ether, polyoxyalkylene alkyl ether, sorbitan fatty acid ester, and polyoxyethylene sorbitan fatty acid ester.

The electrode binder composition according to the present embodiment can be produced by a method of mixing an electrode binder, an aqueous medium, and a component other than the electrode binder and the aqueous medium that is contained as necessary.

### <3. Slurry for Nonaqueous Secondary Battery Electrode>

A slurry for a nonaqueous secondary battery electrode according to the present embodiment (hereinafter, may be referred to as “electrode slurry”) contains an electrode binder, an electrode active material, and an aqueous medium.

Each of the electrode binder and the electrode active material contained in the electrode slurry according to the present embodiment may be dissolved or dispersed in the aqueous medium. The electrode slurry according to the present embodiment may contain at least one of a conductive assistant and a thickener as necessary. It is preferable that the electrode slurry does not contain a thickener to simplify the process of producing the electrode slurry.

The method of preparing the electrode slurry is not particularly limited as long as it is possible to uniformly dissolve or disperse the electrode binder and the electrode active material in an aqueous medium. The electrode slurry according to the present embodiment may be produced by a method of mixing the electrode binder composition according to the present embodiment, the electrode active material, and the aqueous medium that is further added as necessary, or a method of mixing the electrode binder according to the present embodiment, the electrode active material, and the aqueous medium.

Examples of the method of preparing the electrode slurry include a method of mixing materials of the electrode slurry using a mixing device such as a stirring type, a rotation type, or an oscillation type.

The nonvolatile content concentration of the electrode slurry can be adjusted by the amount of the aqueous medium contained in the electrode slurry. The nonvolatile content of the electrode slurry includes the copolymer (P) in the electrode binder, the electrode active material, and the conductive assistant that is contained as necessary. Unless otherwise specified, the nonvolatile content concentration of the electrode slurry is a proportion of the mass of the component remaining after 1 g of the electrode slurry is weighed in an aluminum dish having a diameter of 5 cm and dried at 110° C. for 5 hours during air circulation in a dryer under atmospheric pressure, to the mass before drying.

The nonvolatile content concentration of the electrode slurry is preferably 30 mass % or more, and more preferably 40 mass % or more. This is because, in a case where the electrode slurry is applied onto a collector and dried to form an electrode active material layer, the energy required for drying can be reduced. The nonvolatile content concentration of the electrode slurry is preferably 70 mass % or less, and more preferably 60 mass % or less. This is because, in a case where the electrode slurry is applied onto a collector and dried to form an electrode active material layer, the electrode slurry has such viscosity that it is easily applied.

### <3-1. Amount of Electrode Binder>

The amount of the electrode binder in the electrode slurry is preferably 0.5 mass % or more, more preferably 1.0 mass % or more, and still more preferably 2.0 mass % or more with respect to the total mass of the electrode binder, the electrode active material, and the conductive assistant that is contained as necessary. This is because, in a case where the electrode slurry is applied onto a collector and dried to form an electrode active material layer, it is possible to obtain an electrode active material layer having improved binding properties between the electrode active material particles and between the electrode active material particles and the collector.

The amount of the electrode binder in the electrode slurry is preferably 10 mass % or less, more preferably 7.0 mass % or less, and still more preferably 5.0 mass % or less with respect to the total mass of the electrode binder, the electrode active material, and the conductive assistant that is contained as necessary. This is because, by applying the electrode slurry onto a collector and drying the electrode slurry to form an electrode active material layer, a nonaqueous secondary battery electrode that makes it possible to form a battery having a large charge and discharge capacity and low internal resistance can be obtained.

### <3-2. Electrode Active Material>

In a case where the electrode slurry is used in the formation of a negative electrode active material layer that is an electrode active material layer of a lithium ion secondary battery, for example, the following negative electrode active materials can be used as an electrode active material. Only one kind of the negative electrode active material may be used or two or more kinds thereof may be used.

Examples of the negative electrode active material include a conductive polymer, a carbon material, lithium titanate, silicon, and a silicon compound. Among these negative electrode active materials, any one or two or more selected from a carbon material, lithium titanate, silicon, and a silicon compound is preferably used since it is possible to obtain a lithium ion secondary battery having a high energy density per volume.

Examples of the conductive polymer include polyacetylene and polypyrrole. Examples of the carbon material include cokes such as petroleum coke, pitch coke, and coal coke; and graphite such as artificial graphite and natural graphite. Examples of the artificial graphite include SCMG (registered trademark)-XRs (manufactured by Resonac Holdings Corporation). Examples of the silicon compound include a silicon oxide, and specific examples thereof include SiOₓ (0.1≤x≤2.0).

In addition, the negative electrode active material preferably includes at least one of silicon and a silicon compound and a carbon material such as graphite. This is because the effect of improving the binding properties between the negative electrode active materials and between the negative electrode active material and the collector by the electrode binder according to the present embodiment is more remarkably exhibited. In particular, since it is possible to obtain a lithium ion secondary battery having a high energy density per volume and a high discharge capacity maintenance rate after a charging and discharging cycle, the negative electrode active material preferably includes silicon or a silicon compound, and graphite, and more preferably SiOₓ (0.1≤x≤2.0) as a silicon oxide and graphite.

The negative electrode active material contained in the electrode slurry preferably includes 5 mass % or more, more preferably 10 mass % or more, and still more preferably 15 mass % or more of silicon or a silicon compound with respect to the total amount of the negative electrode active material. In a case where the negative electrode active material contained in the electrode slurry includes 5 mass % or more of silicon or a silicon compound, a negative electrode active material layer containing a negative electrode active material including 5 mass % or more of silicon or a silicon compound can be obtained by applying the electrode slurry onto a collector and drying the electrode slurry. The negative electrode active material layer has good binding properties between the negative electrode active materials and between the negative electrode active material and the collector. This is because the copolymer (P) contained in the negative electrode active material layer has good binding properties to silicon and a silicon compound. Therefore, in the present embodiment, even in a nonaqueous secondary battery electrode including a negative electrode active material layer in which a negative electrode active material includes 5 mass % or more of silicon or a silicon compound, the negative electrode active material layer is less likely to swell due to charging and discharging of a nonaqueous secondary battery including the nonaqueous secondary battery electrode, and thus the discharge capacity maintenance rate after a charging and discharging cycle is high while a further increase in capacity is achieved.

In addition, the amount of the silicon or silicon compound in the negative electrode active material is preferably 50 mass % or less, more preferably 30 mass % or less, and still more preferably 25 mass % or less with respect to the total amount of the negative electrode active material. This is because, in a case where the amount of the silicon or silicon compound in the negative electrode active material is 50 mass % or less, it may be possible to obtain a lithium ion secondary battery having a higher discharge capacity maintenance rate after a charging and discharging cycle while achieving an increase in capacity.

In a case where the electrode slurry is used in the formation of a positive electrode active material layer that is an electrode active material layer of a lithium ion secondary battery, for example, the following positive electrode active material can be used as an electrode active material. Only one kind of the positive electrode active materials may be used or two or more kinds thereof may be used.

Examples of the positive electrode active material include lithium cobaltate (LiCoO₂), lithium composite oxide containing nickel, spinel type lithium manganate (LiMn₂O₄), olivine type lithium iron phosphate, and chalcogen compounds such as TiS₂, MnO₂, MoO₃, and V₂O₅. An oxide of an alkali metal can also be used as the positive electrode active material. Examples of the lithium composite oxide containing nickel include Ni—Co—Mn-based lithium composite oxide, Ni—Mn—Al-based lithium composite oxide, and Ni—Co—Al-based lithium composite oxide. Specific examples of the positive electrode active material include LiNi_{1/3}Mn_{1/3}Co_{1/3}O₂ and LiNi_{3/5}Mn_{1/5}Co_{1/5}O₂.

### <3-3. Conductive Assistant>

The electrode slurry may contain, as a conductive assistant, carbon black such as acetylene black, vapor-grown carbon fiber, or the like. Specific examples of the vapor-grown carbon fiber include VGCF (registered trademark)-H (manufactured by Resonac Holdings Corporation).

### <3-4. Aqueous Medium>

The aqueous medium contained in the electrode slurry contains water. The aqueous medium contained in the electrode slurry may contain a hydrophilic solvent. Examples of the hydrophilic solvent include methanol, ethanol, and N-methylpyrrolidone. The amount of the water in the aqueous medium contained in the electrode slurry is preferably 80 mass % or more, more preferably 90 mass % more, and still more preferably 95 mass % or more, and may be 100 mass %. The aqueous medium contained in the electrode slurry may be the same as or different from the aqueous medium contained in the electrode binder composition.

### <4. Nonaqueous Secondary Battery Electrode>

A nonaqueous secondary battery electrode according to the present embodiment (hereinafter, may be referred to as “electrode”) includes a collector and an electrode active material layer formed on a surface of the collector. The electrode active material layer contains the electrode binder according to the present embodiment and an electrode active material.

The shape of the electrode in a battery is not particularly limited. The electrode in a battery may have, for example, a laminate shape in which a plurality of layers each formed of an electrode are laminated, or a wound body shape in which a layer formed of a strip-like electrode is wound.

The electrode according to the present embodiment may be a positive electrode or a negative electrode. Since the electrode according to the present embodiment includes the electrode active material layer containing the electrode binder according to the present embodiment, the electrode has good binding properties between the electrode active materials and between the electrode active material and the collector in the electrode active material layer, regardless of whether the electrode is a positive electrode or a negative electrode. Moreover, in the electrode according to the present embodiment, since the electrode binder in contact with an electrolytic solution is less likely to swell, the binding properties of the electrode binder are less likely to deteriorate.

As a result, in a nonaqueous secondary battery including the electrode according to the present embodiment, the electrode active material layer is less likely to swell due to charging and discharging, and the nonaqueous secondary battery has a high discharge capacity maintenance rate after a charging and discharging cycle. Moreover, since the electrode according to the present embodiment includes the electrode active material layer containing the electrode binder according to the present embodiment, the flexibility of the electrode active material layer is good and the yield in the production of a nonaqueous secondary battery is good.

The collector of the electrode is preferably formed of a sheet-like metal having a thickness of 0.001 to 0.5 mm. Examples of the metal used for the collector include iron, copper, aluminum, nickel, and stainless steel. In a case where a nonaqueous secondary battery including the electrode is a lithium ion secondary battery, a collector containing aluminum is preferably used as a collector of a positive electrode and a collector containing copper is preferably used as a collector of a negative electrode; however, the collector of a positive electrode and the collector of a negative electrode are not particularly limited thereto.

The electrode according to the present embodiment can be produced by a method including applying an electrode slurry onto a collector and drying the electrode slurry, but the method is not limited thereto.

Examples of the method of applying an electrode slurry onto a collector include a reverse roll method, a direct roll method, a doctor blade method, a knife method, an extrusion method, a curtain method, a gravure method, a bar method, a dip method, and a squeeze method. Among these, a doctor blade method, a knife method, or an extrusion method is preferable, and a doctor blade method is more preferably used for application. This is because these methods are suitable for the physical properties such as viscosity and drying properties of the electrode slurry and a coating film having a good surface state can be obtained.

The electrode slurry may be applied only to one surface of the collector or may be applied to both surfaces. In a case where the electrode slurry is applied to both surfaces of the collector, the electrode slurry may be applied to one surface at a time or both surfaces at the same time. In addition, the electrode slurry may be applied to the entire surface of the collector continuously or intermittently. The amount and the range of the electrode slurry applied can be appropriately determined according to the battery size and the like. The amount of the electrode slurry applied is preferably such an amount that the weight per unit area of the electrode active material layer after drying is 4 to 20 mg/cm², and more preferably 6 to 16 mg/cm².

Next, the electrode slurry applied to the collector is dried. Thus, an electrode sheet is obtained. The method of drying the applied electrode slurry is not particularly limited, and for example, methods selected from hot air, vacuum, (far) infrared rays, electron beams, microwaves, and low-temperature air can be used singly or in combination. The drying temperature is preferably 40° C. or higher and 180° C. or lower. The drying time is preferably 1 minute or longer and 30 minutes or shorter.

The electrode sheet may be used as it is as an electrode or may be used after being cut to have an appropriate size and shape as an electrode. The method of cutting the electrode sheet is not particularly limited, and for example, a slit, a laser, a wire cut, a cutter, a Thomson, or the like can be used.

The electrode sheet may be pressed as necessary, before or after the electrode sheet is cut. This allows the electrode active materials and the electrode active material and the collector to be more firmly bound to each other. In addition, the electrode thickness can be reduced by pressing, and thus the nonaqueous secondary battery can be further downsized.

A general method can be used as a method of pressing the electrode sheet. In particular, a mold pressing method or a roll pressing method is preferably used as a method of pressing the electrode sheet.

The pressing pressure for the electrode sheet is not particularly limited, but the electrode sheet is preferably pressed within a range in which doping/dedoping of lithium ions or the like into the electrode active material is not affected. The pressing pressure for the electrode sheet is preferably 0.5 to 5 t/cm².

### <5. Nonaqueous Secondary Battery>

Next, a lithium ion secondary battery will be described as an example of a nonaqueous secondary battery according to the present embodiment. The lithium ion secondary battery according to the present embodiment has a positive electrode, a negative electrode, an electrolytic solution, and components such as a separator that are provided as necessary, all of which are housed in an exterior body. In the lithium ion secondary battery according to the present embodiment, at least one of the positive electrode and the negative electrode is the electrode according to the present embodiment containing the electrode binder according to the present embodiment.

### <5-1. Electrolytic Solution>

As the electrolytic solution, a nonaqueous liquid having ion conductivity is used. Examples of the electrolytic solution include a solution obtained by dissolving an electrolyte in an organic solvent and an ionic liquid. Since a battery having low internal resistance can be obtained at low production costs, a solution obtained by dissolving an electrolyte in an organic solvent is preferably used as the electrolytic solution.

As the electrolyte, an alkali metal salt can be used. The electrolyte can be appropriately selected depending on the kind of the electrode active material and the like. Examples of the electrolyte include LiClO₄, LiBF₆, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiCF₃SO₃, LiC₄F₉SO₃, Li(CF₃SO₂)₂N, and lithium aliphatic carboxylate.

The organic solvent that dissolves the electrolyte is not particularly limited, and examples thereof include carbonic ester compounds such as ethylene carbonate (EC), propylene carbonate (PC), diethyl carbonate (DEC), ethyl methyl carbonate (EMC), dimethyl carbonate (DMC), fluoroethylene carbonate (FEC), and vinylene carbonate (VC), nitrile compounds such as acetonitrile, and carboxylic esters such as ethyl acetate, propyl acetate, methyl propionate, ethyl propionate, and propyl propionate. These organic solvents may be used singly or in combination of two or more kinds thereof.

### <5-2. Exterior Body>

As the exterior body, a body made of a known material such as a metal or an aluminum laminate material can be appropriately used.

The battery shape may be any one of a coin type, a button type, a sheet type, a cylinder type, a square type, a flat type, or the like.

The electrode binder according to the present embodiment contains a copolymer (P) having a structural unit (a) derived from a monomer (A) represented by General Formula (I) and a structural unit (b) derived from a monomer (B) represented by General Formula (II). In the copolymer (P) contained in the electrode binder according to the present embodiment, the amount of the structural unit (a) is 4.0 mol % or more and 75.0 mol % or less, and the amount of the structural unit (b) is 25.0 mol % or more and 96.0 mol % or less. Therefore, the electrode binder according to the present embodiment can be suitably used as a material of a nonaqueous secondary battery electrode that has an electrode active material layer having good flexibility and makes it possible to obtain a nonaqueous secondary battery having a sufficiently high discharge capacity maintenance rate after a charging and discharging cycle.

In addition, the electrode binder composition and the electrode slurry according to the present embodiment contain the electrode binder according to the present embodiment. Therefore, the electrode binder composition and the electrode slurry can be suitably used as a material of a nonaqueous secondary battery electrode that has an electrode active material layer having good flexibility and makes it possible to obtain a nonaqueous secondary battery having a sufficiently high discharge capacity maintenance rate after a charging and discharging cycle.

The nonaqueous secondary battery electrode according to the present embodiment includes a collector and an electrode active material layer formed on a surface of the collector, and the electrode active material layer contains the electrode binder according to the present embodiment. Therefore, the nonaqueous secondary battery electrode makes it possible to obtain a nonaqueous secondary battery having a sufficiently high discharge capacity maintenance rate after a charging and discharging cycle. In addition, since the electrode active material layer of the nonaqueous secondary battery electrode according to the present embodiment contains the electrode binder according to the present embodiment, the electrode active material layer has good flexibility. Therefore, a nonaqueous secondary battery including the nonaqueous secondary battery electrode according to the present embodiment has good production yield.

Since the nonaqueous secondary battery according to the present embodiment includes the nonaqueous secondary battery electrode according to the present embodiment, the nonaqueous secondary battery can be produced with good yield and has a sufficiently high discharge capacity maintenance rate after a charging and discharging cycle.

### EXAMPLES

Hereinafter, the present invention will be described in greater detail with reference to Examples and Comparative Examples. The following Examples are for making it easier to understand the amount of the present invention. The present invention is not limited only to these Examples.

Specifically, in the following Examples, a case will be described where a negative electrode binder composition for a lithium ion secondary battery is prepared as an example of a binder composition for a nonaqueous secondary battery electrode containing the binder for a nonaqueous secondary battery electrode according to the present invention, but the binder composition for a nonaqueous secondary battery electrode can also be used as a positive electrode binder composition for a lithium ion secondary battery.

In the following Examples, as an example of a binder composition for a nonaqueous secondary battery electrode containing the binder for a nonaqueous secondary battery electrode according to the present invention, a negative electrode binder composition for a lithium ion secondary battery was prepared, a negative electrode slurry, a negative electrode, and a lithium ion secondary battery were prepared using the negative electrode binder composition, and the effects of the present invention were confirmed by comparison with negative electrode binder compositions for a lithium ion secondary battery, negative electrodes, and lithium ion secondary batteries of Comparative Examples.

### <1. Preparation of Negative Electrode Binder Composition>

Table 1 or Table 2 shows monomers (A) to (D) used for synthesis of copolymers (P) of Examples 1 to 14 contained in a negative electrode binder composition, and ratios thereof. Table 3 shows monomers (A) to (D) used for synthesis of copolymers or polymers of Comparative Examples 1 to 8 contained in a negative electrode binder composition, and ratios thereof. Each of the compositional ratios (monomer (A)+monomer (B)) shown in Tables 1 to 3 are a ratio of the total amount of the monomer (A) and the monomer (B) to the total amount of the monomers used for synthesis.

The copolymers (P) of Examples 1 to 14 and the copolymers or polymers of Comparative Examples 1 to 8 were produced in the same manner, except for the kinds and amounts of the monomers and the polymerization initiators used for synthesis.

TABLE 1

| | | Examples | | | | | | | | | | | | | | | |
|---|---|---|---|---|---|---|---|---|---|---|---|---|---|---|---|---|---|
| | | 1 | | 2 | | 3 | | 4 | | 5 | | 6 | | 7 | | 8 | |
| | | Part | | Part | | Part | | Part | | Part | | Part | | Part | | Part | |
| | | by | Mol | by | Mol | by | Mol | by | Mol | by | Mol | by | Mol | by | Mol | by | Mol |
| | | Mass | % | Mass | % | Mass | % | Mass | % | Mass | % | Mass | % | Mass | % | Mass | % |
| Monomer | HEAA | 10 | 8.3 | 30 | 25.9 | 50 | 45.0 | 70 | 65.6 | 40 | 35.5 | 0 | 0.0 | 49 | 43.9 | 10 | 8.0 |
| (A) | N-MAM | 0 | 0.0 | 0 | 0.0 | 0 | 0.0 | 0 | 0.0 | 10 | 10.1 | 50 | 48.2 | 0 | 0.0 | 0 | 0.0 |
| Monomer | AaNa | 90 | 91.7 | 70 | 74.1 | 50 | 55.0 | 30 | 34.4 | 50 | 54.4 | 50 | 51.8 | 50 | 54.9 | 50 | 48.8 |
| (B) | MAaNa | 0 | 0.0 | 0 | 0.0 | 0 | 0.0 | 0 | 0.0 | 0 | 0.0 | 0 | 0.0 | 0 | 0.0 | 0 | 0.0 |
| | AaLi | 0 | 0.0 | 0 | 0.0 | 0 | 0.0 | 0 | 0.0 | 0 | 0.0 | 0 | 0.0 | 0 | 0.0 | 0 | 0.0 |
| Monomer | NVA | 0 | 0.0 | 0 | 0.0 | 0 | 0.0 | 0 | 0.0 | 0 | 0.0 | 0 | 0.0 | 1 | 1.2 | 40 | 43.2 |
| (C) | | | | | | | | | | | | | | | | | |
| Another | AAm | 0 | 0.0 | 0 | 0.0 | 0 | 0.0 | 0 | 0.0 | 0 | 0.0 | 0 | 0.0 | 0 | 0.0 | 0 | 0.0 |
| Monomer | HEA | 0 | 0.0 | 0 | 0.0 | 0 | 0.0 | 0 | 0.0 | 0 | 0.0 | 0 | 0.0 | 0 | 0.0 | 0 | 0.0 |
| (D) | | | | | | | | | | | | | | | | | |
| Compositional | Monomer | 100 | 100.0 | 100 | 100.0 | 100 | 100.0 | 100 | 100.0 | 100 | 100.0 | 100 | 100.0 | 99 | 98.8 | 60 | 56.8 |
| Ratio | (A) + | | | | | | | | | | | | | | | | |
| | Monomer | | | | | | | | | | | | | | | | |
| | (B) | | | | | | | | | | | | | | | | |

| | | | | | | | | | |
|---|---|---|---|---|---|---|---|---|---|
| Copolymer | Weight- | 130 | 150 | 180 | 200 | 180 | 200 | 160 | 100 |
| Characteristics | Average | | | | | | | | |
| | Molecular | | | | | | | | |
| | Weight (ten | | | | | | | | |
| | thousand) | | | | | | | | |
| Electrode | Appearance | 1 | 1 | 1 | 1 | 1 | 1 | 0 | 0 |
| Characteristics | (number of | | | | | | | | |
| | aggregates) | | | | | | | | |
| | Flexibility | 2 | 1 | 0 | 0 | 0 | 2 | 0 | 2 |
| | (winding | | | | | | | | |
| | test) | | | | | | | | |
| Battery | Discharge | 94.6 | 94.3 | 94.5 | 93.5 | 93.5 | 92.5 | 94.3 | 94.5 |
| Characteristics | Capacity | | | | | | | | |
| | Maintenance | | | | | | | | |
| | Rate (%) | | | | | | | | |

TABLE 2

| | | Examples | | | | | | | | | | | |
|---|---|---|---|---|---|---|---|---|---|---|---|---|---|
| | | 9 | | 10 | | 11 | | 12 | | 13 | | 14 | |
| | | Part by | | Part by | | Part by | | Part by | | Part by | | Part by | |
| | | Mass | Mol % | Mass | Mol % | Mass | Mol % | Mass | Mol % | Mass | Mol % | Mass | Mol % |
| Monomer (A) | HEAA | 50 | 48.4 | 50 | 40.4 | 50 | 45.0 | 50 | 45.0 | 50 | 45.0 | 27 | 21.5 |
| | N-MAM | 0 | 0.0 | 0 | 0.0 | 0 | 0.0 | 0 | 0.0 | 0 | 0.0 | 0 | 0.0 |
| Monomer (B) | AaNa | 0 | 0.0 | 0 | 0.0 | 50 | 55.0 | 50 | 55.0 | 50 | 55.0 | 50 | 48.8 |
| | MAaNa | 50 | 51.6 | 0 | 0.0 | 0 | 0.0 | 0 | 0.0 | 0 | 0.0 | 0 | 0.0 |
| | AaLi | 0 | 0.0 | 50 | 59.6 | 0 | 0.0 | 0 | 0.0 | 0 | 0.0 | 0 | 0.0 |
| Monomer (C) | NVA | 0 | 0.0 | 0 | 0.0 | 0 | 0.0 | 0 | 0.0 | 0 | 0.0 | 0 | 0.0 |
| Another | AAm | 0 | 0.0 | 0 | 0.0 | 0 | 0.0 | 0 | 0.0 | 0 | 0.0 | 23 | 29.7 |
| Monomer (D) | HEA | 0 | 0.0 | 0 | 0.0 | 0 | 0.0 | 0 | 0.0 | 0 | 0.0 | 0 | 0.0 |
| Compositional | Monomer (A) + | 100 | 100.0 | 100 | 100.0 | 100 | 100.0 | 100 | 100.0 | 100 | 100.0 | 77 | 70.3 |
| Ratio | Monomer | | | | | | | | | | | | |
| | (B) | | | | | | | | | | | | |

| | | | | | | | |
|---|---|---|---|---|---|---|---|
| Copolymer | Weight- | 110 | 200 | 40 | 80 | 300 | 230 |
| Characteristics | Average | | | | | | |
| | Molecular | | | | | | |
| | Weight (ten | | | | | | |
| | thousand) | | | | | | |
| Electrode | Appearance | 1 | 1 | 1 | 1 | 1 | 1 |
| Characteristics | (number of | | | | | | |
| | aggregates) | | | | | | |
| | Flexibility | 0 | 0 | 0 | 0 | 0 | 0 |
| | (winding test) | | | | | | |
| Battery | Discharge | 93.8 | 93.0 | 92.2 | 93.5 | 94.6 | 93.9 |
| Characteristics | Capacity | | | | | | |
| | Maintenance | | | | | | |
| | Rate (%) | | | | | | |

TABLE 3

| | | Comparative Example | | | | | | | | | | | | | | | |
|---|---|---|---|---|---|---|---|---|---|---|---|---|---|---|---|---|---|
| | | 1 | | 2 | | 3 | | 4 | | 5 | | 6 | | 7 | | 8 | |
| | | Part | | Part | | Part | | Part | | Part | | Part | | Part | | Part | |
| | | by | Mol | by | Mol | by | Mol | by | Mol | by | Mol | by | Mol | by | Mol | by | Mol |
| | | Mass | % | Mass | % | Mass | % | Mass | % | Mass | % | Mass | % | Mass | % | Mass | % |
| Monomer | HEAA | 0 | 0.0 | 0 | 0.0 | 0 | 0.0 | 0 | 0.0 | 2 | 1.6 | 85 | 82.2 | 100 | 100.0 | 8 | 5.4 |
| (A) | N-MAM | 0 | 0.0 | 0 | 0.0 | 0 | 0.0 | 0 | 0.0 | 0 | 0.0 | 0 | 0.0 | 0 | 0.0 | 0 | 0.0 |
| Monomer | AaNa | 100 | 100.0 | 80 | 78.4 | 50 | 43.0 | 90 | 91.7 | 98 | 98.4 | 15 | 17.8 | 0 | 0.0 | 25 | 20.8 |
| (B) | MAaNa | 0 | 0.0 | 0 | 0.0 | 0 | 0.0 | 0 | 0.0 | 0 | 0.0 | 0 | 0.0 | 0 | 0.0 | 0 | 0.0 |
| | AaLi | 0 | 0.0 | 0 | 0.0 | 0 | 0.0 | 0 | 0.0 | 0 | 0.0 | 0 | 0.0 | 0 | 0.0 | 0 | 0.0 |
| Monomer | NVA | 0 | 0.0 | 20 | 21.6 | 0 | 0.0 | 0 | 0.0 | 0 | 0.0 | 0 | 0.0 | 0 | 0.0 | 0 | 0.0 |
| (C) | | | | | | | | | | | | | | | | | |
| Another | AAm | 0 | 0.0 | 0 | 0.0 | 50 | 57.0 | 0 | 0.0 | 0 | 0.0 | 0 | 0.0 | 0 | 0.0 | 67 | 73.8 |
| Monomer | HEA | 0 | 0.0 | 0 | 0.0 | 0 | 0.0 | 10 | 8.3 | 0 | 0.0 | 0 | 0.0 | 0 | 0.0 | 0 | 0.0 |
| (D) | | | | | | | | | | | | | | | | | |
| Compositional | Monomer | 100 | 100.0 | 80 | 78.4 | 50 | 43.0 | 90 | 91.7 | 100 | 100.0 | 100 | 100.0 | 100 | 100.0 | 33 | 26.2 |
| Ratio | (A) + | | | | | | | | | | | | | | | | |
| | Monomer | | | | | | | | | | | | | | | | |
| | (B) | | | | | | | | | | | | | | | | |

| | | | | | | | | | |
|---|---|---|---|---|---|---|---|---|---|
| Copolymer | Weight- | 180 | 140 | 200 | 160 | 180 | 200 | 220 | 230 |
| Characteristics | Average | | | | | | | | |
| | Molecular | | | | | | | | |
| | Weight (ten | | | | | | | | |
| | thousand) | | | | | | | | |
| Electrode | Appearance | 4 | 0 | 2 | 2 | 4 | 1 | 6 | 1 |
| Characteristics | (number of | | | | | | | | |
| | aggregates) | | | | | | | | |
| | Flexibility | 15 | 12 | 12 | 1 | 12 | 0 | 0 | 3 |
| | (winding | | | | | | | | |
| | test) | | | | | | | | |
| Battery | Discharge | 90.1 | 93.5 | 91.9 | 90.5 | 91.5 | 89.0 | 86.0 | 90.5 |
| Characteristics | Capacity | | | | | | | | |
| | Maintenance | | | | | | | | |
| | Rate (%) | | | | | | | | |

The monomers (A) to (D) shown in Tables 1 to 3 are compounds shown below. In a case where an aqueous solution containing any one or more selected from the monomers (A) to (D) is used for synthesis of the copolymer or polymer, the amounts of the monomers (A) to (D) used, shown in Tables 1 to 3, are the amounts of the monomers (A) to (D) themselves in the aqueous solution, and no water is included, which is a solvent.

### (Monomer (A))

N-hydroxyethyl acrylamide (HEAA)
N-methylol acrylamide (N-MAM)

### (Monomer (B))

Sodium acrylate (AaNa) (28.5 mass % aqueous solution)
Sodium methacrylate (MAaNa) (28.5 mass % aqueous solution)
Lithium acrylate (AaLi) (28.5 mass % aqueous solution)

### (Monomer (C))

N-vinylacetamide (NVA) (manufactured by Resonac Holdings Corporation) (Another Monomers (D))
Acrylamide (AAm) (50.0 mass % aqueous solution)
2-hydroxyethyl acrylate (HEA)

In addition, details of the radical polymerization initiators used for synthesis of the copolymers (P) of Examples 1 to 14 and the copolymers or polymers of Comparative Examples 1 to 8 are as follows.

### (Radical Polymerization Initiator)

2,2′-azobis(2-methylpropionamidine) dihydrochloride (V-50) (manufactured by FUJIFILM Wako Pure Chemical Corporation)
Ammonium persulfate (manufactured by FUJIFILM Wako Pure Chemical Corporation)

### <1-1. Preparation of Negative Electrode Binder Compositions of Examples 1 to 10 and 14 and Comparative Examples 1 to 8>

A total of 100 parts by mass of monomers including the monomers (A) to (D) in the ratios shown in Tables 1 to 3, 0.2 parts by mass of 2,2′-azobis(2-methylpropionamidine) dihydrochloride as a radical polymerization initiator, 0.05 parts by mass of ammonium persulfate, and 567 parts by mass of water were charged at 30° C. in a separable flask equipped with a cooling pipe, a thermometer, a stirrer, and a dropping funnel. The temperature was raised to 80° C. and polymerization was performed for 4 hours to generate a copolymer or polymer. Thus, a reaction liquid containing the copolymer or polymer was obtained.

Water was added to the reaction liquid containing the copolymer or polymer after polymerization, and thus negative electrode binder compositions of Examples 1 to 10 and 14 and Comparative Examples 1 to 8 were obtained in which the nonvolatile amount concentration was 10.0 mass %. In the synthesis of the copolymer or polymer, the amount of the water in the aqueous solution used as a monomer (sodium acrylate, sodium methacrylate, lithium acrylate, or acrylamide) is included in the amount of the water in the negative electrode binder compositions of Examples 1 to 10 and 14 and Comparative Examples 1 to 8.

### <1-2. Preparation of Negative Electrode Binder Composition of Example 11>

A negative electrode binder composition of Example 11 was obtained in the same manner as in Example 3, except that the amount of 2,2′-azobis(2-methylpropionamidine) dihydrochloride charged as a radical polymerization initiator was 0.8 parts by mass and the amount of ammonium persulfate charged was 0.20 parts by mass.

### <1-3. Preparation of Negative Electrode Binder Composition of Example 12>

A negative electrode binder composition of Example 12 was obtained in the same manner as in Example 3, except that the amount of 2,2′-azobis(2-methylpropionamidine) dihydrochloride charged as a radical polymerization initiator was 0.4 parts by mass and the amount of ammonium persulfate charged was 0.10 parts by mass.

### <1-4. Preparation of Negative Electrode Binder Composition of Example 13>

A negative electrode binder composition of Example 13 was obtained in the same manner as in Example 3, except that the amount of 2,2′-azobis(2-methylpropionamidine) dihydrochloride charged as a radical polymerization initiator was 0.1 parts by mass and the amount of ammonium persulfate charged was 0.03 parts by mass.

### <2. Weight-Average Molecular Weight of Copolymer or Polymer>

The weight-average molecular weight of the copolymer or polymer contained in each of the negative electrode binder compositions of Examples 1 to 14 and Comparative Examples 1 to 8 was measured under the following conditions using gel permeation chromatography (GPC). The results are shown in Tables 1 to 3.
GPC device: GPC-101 (manufactured by Resonac Holdings Corporation)
Solvent: 0.1 M NaNO₃ aqueous solution
Sample column: Two columns Shodex Ohpak SB-806 HQ (8.0 mm I.D.×300 mm) (manufactured by Resonac Holdings Corporation)
Reference column: Two columns Shodex Ohpak SB-800 RL (8.0 mm I.D.×300 mm) (manufactured by Resonac Holdings Corporation)
Column temperature: 40° C.
Sample concentration: 0.1 mass %
Detector: RI-71S (manufactured by Shimadzu Corporation)
Pump: DU-H2000 (manufactured by Shimadzu Corporation)
Pressure: 1.3 MPa
Flow rate: 1 ml/min
Molecular weight standard: Pullulan (P-5, P-10, P-20, P-50, P-100, P-200, P-400, P-800, P-1300, and P-2500 (manufactured by Resonac Holdings Corporation)

### <3. Preparation of Negative Electrode>

76.8 parts by mass of graphite SCMG (registered trademark)-XRs (manufactured by Resonac Holdings Corporation) as a negative electrode active material and 19.2 parts by mass of a silicon monoxide (SiO) (manufactured by Sigma-Aldrich Co., LLC) were prepared. In addition, 1 part by mass of VGCF (registered trademark)-H (manufactured by Resonac Holdings Corporation) was prepared as a conductive assistant.

Then, the negative electrode active material, the conductive assistant, 30 parts by mass (3 parts by mass of the copolymer or polymer and 27 parts by mass of water) of the negative electrode binder composition of any one of Examples 1 to 14 and Comparative Examples 1 to 8, and 20 parts by mass of water were mixed to obtain a mixture. The mixing was performed through a kneading method at a rotation speed of 2,000 rpm for 4 minutes using a stirring type mixing device (planetary centrifugal mixer). To the obtained mixture, 53 parts by mass of water was further added and mixed at a rotation speed of 2,000 rpm for 4 minutes using the above-described mixing device to obtain negative electrode slurries of Examples 1 to 14 and Comparative Examples 1 to 8.

Each of the prepared negative electrode slurries of Examples 1 to 14 and Comparative Examples 1 to 8 was applied to one surface of a collector formed of copper foil having a thickness of 10 μm using a doctor blade method so that the weight per unit area after drying was 8 mg/cm². The copper foil with the negative electrode slurry applied thereto was dried at 60° C. for 10 minutes, and then further dried at 100° C. for 5 minutes to form a negative electrode active material layer, thereby preparing a negative electrode sheet. Two negative electrode sheet pieces having a width of 50 mm and a length of 60 mm were cut out from the obtained negative electrode sheet. Each of the negative electrode sheet pieces cut out was pressed once at a pressing pressure of 1 t/cm² using a mold press.

One of the two pressed negative electrode sheet pieces was cut out into a square of 22 mm×22 mm, and a conductive tab was attached thereto to obtain a negative electrode. The other of the two pressed negative electrode sheet pieces was used for the evaluation of the negative electrode shown below.

### <4. Evaluation of Negative Electrode>

The electrode characteristics of the negative electrodes of Examples 1 to 14 and Comparative Examples 1 to 8 were evaluated by the following method. The results are shown in Tables 1 to 3.

### <4-1. Evaluation of Appearance (Number of Aggregates) of Negative Electrode Active Material Layer>

Regarding the pressed negative electrode sheet piece having a width of 50 mm and a length of 60 mm, which had been prepared in the section <3. Preparation of Negative Electrode>, the appearance of the entire negative electrode active material layer was visually observed, and the number of aggregates in the negative electrode active material layer was counted.

### <4-2. Evaluation of Flexibility of Negative Electrode Active Material Layer (Winding Test)>

The pressed negative electrode sheet piece having a width of 50 mm and a length of 60 mm, which had been prepared in the section <4. Preparation of Negative Electrode>, was used as a test piece and dried at 80° C. for 12 hours. Then, one end of the dried test piece in a length direction was fixed to a stainless steel rod having a diameter of 3 mm using a tape having a thickness of 50 μm, and the other end thereof was fixed to a glass plate. Then, a length direction of the stainless steel rod was arranged substantially parallel to a width direction of the test piece, and the test piece was wound around the stainless steel rod with a surface of the test piece on the negative electrode active material layer side facing the stainless steel rod side (inside). In this case, the test piece was wound so that wrinkles and sagging did not occur, and the test piece wound around the stainless steel rod and the test piece wound on the wound test piece were brought into close contact with each other. Next, the entire wound test piece was unwound from the stainless steel rod around which the test piece had been wound, and was spread out flat. Then, the appearance of the entire negative electrode active material layer of the test piece was visually observed, and the number of cracks in the negative electrode active material layer was counted.

### <5. Preparation of Positive Electrode>

90 parts by mass of LiNi_{1/3}Mn_{1/3}Co_{1/3}O₂ as a positive electrode active material, 5 parts by mass of acetylene black as a conductive assistant, and 5 parts by mass of polyvinylidene fluoride as a positive electrode binder were mixed to obtain a mixture. 100 parts by mass of N-methylpyrrolidone as a solvent was added to the obtained mixture and mixed, and thus a positive electrode slurry (the ratio of LiNi_{1/3}Mn_{1/3}Co_{1/3}O₂ in the solid content was 90 mass %) was obtained.

The prepared positive electrode slurry was applied to one surface of a collector formed of aluminum foil having a thickness of 20 μm using a doctor blade method so that the weight per unit area after drying was 22.5 mg/cm². The aluminum foil with the positive electrode slurry applied thereto was dried at 120° C. for 5 minutes to form a positive electrode active material layer, and a positive electrode sheet was prepared. The obtained positive electrode sheet was pressed by a roll press to obtain a positive electrode sheet having a positive electrode active material layer having a thickness of 100 μm. The pressed positive electrode sheet was cut out into a square of 20 mm×20 mm, and a conductive tab was attached thereto to obtain a positive electrode.

The theoretical capacity of the prepared positive electrode was calculated by the following expression using the weight per unit area (22.5×10⁻³ g/cm²) of the positive electrode slurry after drying, the area (2.0 cm×2.0 cm) of the positive electrode slurry applied, the capacity (160 mAh/g) of LiNi_{1/3}Mn₁₃Co_{1/3}O₂ as a positive electrode active material, and the ratio (0.90) of LiNi_{1/3}Mn_{1/3}Co_{1/3}O₂ in the solid content. As a result, the theoretical capacity of the positive electrode was 13 mAh.

Theoretical Capacity (mAh) of Positive Electrode=Weight per Unit Area of Positive Electrode Slurry After Drying×Area of Positive Electrode Slurry Applied×Capacity of Positive Electrode Active Material×Ratio of Positive Electrode Active Material in Solid Content of Positive Electrode Slurry

### <6. Preparation of Electrolytic Solution>

Ethylene carbonate (EC), ethyl methyl carbonate (EMC), and diethyl carbonate (DEC) were mixed at a volume ratio of 30:50:20 to obtain a mixed solvent. To the obtained mixed solvent, LiPF₆ was added as an electrode active material to a concentration of 1.0 mol/L, vinylene carbonate (VC) was dissolved to a concentration of 1.0 mass %, and fluoroethylene carbonate (FEC) was dissolved to a concentration of 2.0 mass % to obtain an electrolytic solution.

### <7. Assembly of Battery>

The positive electrode and any one of the negative electrodes of Examples 1 to 14 and Comparative Examples 1 to 8 were arranged with a separator formed of a polyolefin porous film interposed therebetween so that the active material layers thereof faced each other. These were housed in an exterior body (battery pack) formed of an aluminum laminate material. Then, the electrolytic solution was injected into the exterior body, and the opening portion of the exterior body was packed using a vacuum heat sealer. Through the above steps, laminated batteries of Examples 1 to 14 and Comparative Examples 1 to 8 were obtained.

### <8. Evaluation of Battery>

Battery characteristics of the batteries of Examples 1 to 14 and Comparative Examples 1 to 8 were evaluated by the following methods. The results are shown in Tables 1 to 3.

### <8-1. Discharge Capacity Maintenance Rate (100 Cycles) of Battery>

In order to obtain the discharge capacity maintenance rate of the battery, the battery was subjected to a charging and discharging cycle test under a condition of a temperature of 25° C. according to the following procedure.

First, charging was performed with a current of 1 C until the voltage reached 4.2 V (CC charging). Next, charging was performed with a voltage of 4.2 V until the current reached 0.05 C (CV charging). After leaving for 30 minutes, discharging was performed with a current of 1 C until the voltage reached 2.75 V (CC discharging). A series of operations including CC charging, CV charging, and CC discharging was defined as one cycle, and 100 cycles were performed.

Next, the sum of time integral values of the currents in the CC charging and the CV charging at an n-th cycle was defined as a charge capacity (mAh) at the n-th cycle, a time integral value of the current in the CC discharging at the n-th cycle was defined as a discharge capacity (mAh) at the n-th cycle, and the discharge capacity maintenance rate of the battery at a 100-th cycle was obtained by the following expression.

Discharge Capacity Maintenance Rate (%) at 100-th Cycle=(Discharge Capacity at 100-th Cycle/Discharge Capacity at First Cycle)×100

### <9. Evaluation Results>

As shown in Tables 1 and 2, the negative electrodes of Examples 1 to 14 had two or less cracks in the negative electrode active material layer and had good flexibility. Moreover, the negative electrodes of Examples 1 to 14 had a good appearance with one or less aggregates in the negative electrode active material layer.

In addition, it was possible to confirm that the batteries of Examples 1 to 14 had good battery characteristics with a discharge capacity maintenance rate of 92% or more at the 100-th cycle.

On the other hand, as shown in Table 3, the negative electrode of Comparative Example 1, in which a polymer obtained by polymerizing only the monomer (B) without using the monomer (A) was contained, had 15 cracks in the negative electrode active material layer and had very poor flexibility. The negative electrode of Comparative Example 1 also had an insufficient appearance with four aggregates in the negative electrode active material layer.

In addition, the battery of Comparative Example 1 also had insufficient battery characteristics with a discharge capacity maintenance rate of 90.1% at the 100-th cycle.

These results are presumed to be due to the fact that, in Comparative Example 1, the polymer contained as a binder in the negative electrode active material layer does not include the structural unit (a) derived from the monomer (A).

In addition, as shown in Table 3, the negative electrode of Comparative Example 2, in which a copolymer obtained using the monomer (C) instead of the monomer (A) was contained, had 12 cracks in the negative electrode active material layer and had very poor flexibility.

In addition, as shown in Table 3, the negative electrode of Comparative Example 3, in which a copolymer obtained using acrylamide as another monomer (D) instead of the monomer (A) was contained, had 12 cracks in the negative electrode active material layer and had very poor flexibility. In addition, the battery of Comparative Example 3 also had insufficient battery characteristics with a discharge capacity maintenance rate of 91.9% at the 100-th cycle.

In addition, as shown in Table 3, the negative electrode of Comparative Example 4, in which a copolymer obtained using hydroxyethyl acrylate as another monomer (D) instead of the monomer (A) was contained, had insufficient battery characteristics with a discharge capacity maintenance rate of 90.5% at the 100-th cycle.

The results are presumed to be due to the fact that, in Comparative Examples 2 to 4, the copolymer contained as a binder in the negative electrode active material layer does not include the structural unit (a) derived from the monomer (A), and thus the negative electrode characteristics and the battery characteristics are insufficient.

In addition, as shown in Table 3, the negative electrode of Comparative Example 5, in which the amount of the monomer (A) used for synthesis of the copolymer (P) was 2 mol %, had 12 cracks in the negative electrode active material layer and had very poor flexibility. The negative electrode of Comparative Example 5 also had an insufficient appearance with four aggregates in the negative electrode active material layer.

In addition, the battery of Comparative Example 5 also had insufficient battery characteristics with a discharge capacity maintenance rate of 91.5% at the 100-th cycle.

These results are presumed to be due to the fact that, in Comparative Example 5, the amount of the structural unit (a) derived from the monomer (A) is insufficient in the copolymer contained as a binder in the negative electrode active material layer.

In addition, as shown in Table 3, the battery of Comparative Example 6, in which the amount of the monomer (A) used for synthesis of the copolymer (P) was 82 mol % and the amount of the monomer (B) was 18 mol %, had insufficient battery characteristics with a discharge capacity maintenance rate of 89.0% at the 100-th cycle.

The results are presumed to be due to the fact that, in Comparative Example 6, the amount of the structural unit (a) derived from the monomer (A) is excessive and the amount of the structural unit (b) derived from the monomer (B) is insufficient in the copolymer contained as a binder in the negative electrode active material layer.

In addition, as shown in Table 3, the negative electrode of Comparative Example 7, in which a polymer obtained by polymerizing only the monomer (A) without using the monomer (B) was contained, had an insufficient appearance with six aggregates in the negative electrode active material layer.

In addition, the battery of Comparative Example 7 also had insufficient battery characteristics with a discharge capacity maintenance rate of 86.0% at the 100-th cycle.

These results are presumed to be due to the fact that, in Comparative Example 7, the polymer contained as a binder in the negative electrode active material layer does not include the structural unit (b) derived from the monomer (B).

In addition, as shown in Table 3, the battery of Comparative Example 8, in which the amount of the monomer (A) used for synthesis of the copolymer (P) was 5 mol % and the amount of the monomer (B) was 21 mol %, had insufficient battery characteristics with a discharge capacity maintenance rate of 90.5% at the 100-th cycle.

The results are presumed to be due to the fact that, in Comparative Example 8, the amount of the structural unit (b) derived from the monomer (B) is insufficient in the copolymer contained as a binder in the negative electrode active material layer.

1. A binder, comprising:
a copolymer (P) having
a structural unit (a) derived from a monomer (A) represented by General Formula (I), and
a structural unit (b) derived from a monomer (B) represented by General Formula (II),
wherein an amount of the structural unit (a) with respect to a total amount of the copolymer (P) is 4.0 mol % or more and 75.0 mol % or less, and an amount of the structural unit (b) with respect to a total amount of the copolymer (P) is 25.0 mol % or more and 96.0 mol % or less, 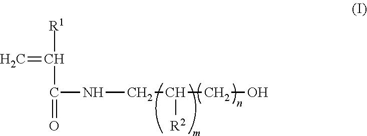
in Formula (I), R¹ represents a hydrogen atom or a methyl group, R² represents a hydrogen atom or a hydroxy group, and m and n each independently represent 0 or 1, 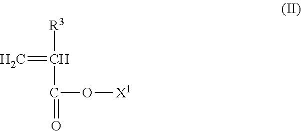
in Formula (II), R³ represents a hydrogen atom, a methyl group, or CH₂COOX², and X¹ and X² each independently represent a hydrogen atom, an alkali metal, or NH₄.

2. The binder according to claim 1,
wherein the copolymer (P) has a structural unit (c) derived from a monomer (C) represented by General Formula (III), and
an amount of the structural unit (c) in the copolymer (P) is 0.5 mol % or more and 55.0 mol % or less, 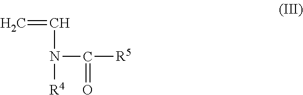
in Formula (III), R⁴ and R⁵ each independently represent a hydrogen atom or an alkyl group having 1 or more and 5 or less carbon atoms.

3. The binder according to claim 1,
wherein the monomer (A) includes at least any one of N-hydroxyethyl acrylamide or N-methylol acrylamide.

4. The binder according to claim 1,
wherein the monomer (B) includes at least any one of sodium (meth)acrylate or lithium (meth)acrylate.

5. The binder according to claim 2,
wherein the monomer (C) includes at least any one of N-vinylformamide or N-vinylacetamide.

6. The binder according to claim 1,
wherein a weight-average molecular weight of the copolymer (P) is within a range of 300,000 or more and 5,000,000 or less.

7. The binder according to claim 1,
wherein a weight-average molecular weight of the copolymer (P) is within a range of 1,500,000 or more and 5,000,000 or less.

8. The binder according to claim 1,
wherein a sum of the amount of the structural unit (a) and the amount of the structural unit (b) with respect to the total amount of the copolymer (P) is 55.0 mol % or more.

9. (canceled)

10. A binder composition, comprising:
the binder according to claim 1; and
an aqueous medium.

11. A slurry, comprising:
the binder according to claim 1;
an electrode active material; and
an aqueous medium.

12. A nonaqueous secondary battery electrode comprising:
a collector; and
an electrode active material layer formed on a surface of the collector,
wherein the electrode active material layer contains the binder according to claim 1 and an electrode active material.

13. The nonaqueous secondary battery electrode according to claim 12,
wherein the electrode active material contains 5 mass % or more of silicon or a silicon compound with respect to a total amount of the electrode active material.

14. A nonaqueous secondary battery comprising:
the nonaqueous secondary battery electrode according to claim 12.
